(19) United States
(12) Patent Application Publication
(10) Pub. No.: US 2025/0316071 A1
(43) Pub. Date: Oct. 9, 2025

(54) METHOD FOR TUNING IMAGE SIGNAL PROCESSOR AND ELECTRONIC DEVICE

(71) Applicant: Samsung Electronics Co., Ltd., Suwon-si (KR)

(72) Inventors: Muncheon KANG, Suwon-si (KR); Woongbum HWANG, Suwon-si (KR); Joohyun LEE, Suwon-si (KR); Jongseong CHOI, Suwon-si (KR)

(73) Assignee: Samsung Electronics Co., Ltd., Suwon-si (KR)

(21) Appl. No.: 19/090,942

(22) Filed: Mar. 26, 2025

(30) Foreign Application Priority Data
Apr. 5, 2024 (KR) 10-2024-0046963
Jul. 29, 2024 (KR) 10-2024-0100547

(51) Int. Cl. G06V 10/82; G06V 10/40; G06V 10/77; G06V 10/771; G06V 10/774; G06V 10/98

(52) U.S. Cl. CPC G06V 10/82; G06V 10/40; G06V 10/7715; G06V 10/7747; G06V 10/98; G06V 10/771

(57) ABSTRACT

A method of tuning an image signal processor by an electronic device includes: obtaining an image evaluation model for receiving an image and outputting an evaluation on the image; determining key features of the image based on the image evaluation model; determining a parameter list based on the key features; and training, based on the parameter list and the image evaluation model, a tuning model for receiving an image and outputting a parameter adjustment set, wherein the tuning model is a reinforcement learning model.

### CROSS-REFERENCE TO RELATED APPLICATION(S)

This application is based on and claims priority under 35 U.S.C. § 119 to Korean Patent Application Nos. 10-2024-0046963, filed on Apr. 5, 2024, and 10-2024-0100547, filed on Jul. 29, 2024, in the Korean Intellectual Property Office, the disclosures of which are incorporated by reference herein in their entireties.

### BACKGROUND

The inventive concepts relate to an electronic device, and more particularly, to an electronic device configured to tune an image signal processor, and a method of operating the electronic device.

One of the main roles of a camera system is to provide good quality images. In general, a camera system processes a raw image generated from an image sensor included in the camera system by using an image signal processor (ISP) included in the camera system, and generally displays the processed image through a display.

The image signal processor includes a pipeline including a plurality of image processing blocks, and the total number of parameters used in each of the plurality of image processing blocks is in the thousands. Accordingly, in order to provide image quality that satisfies user demands, engineers may directly analyze the features of thousands of parameters and adjust each of the thousands of parameters based on the analysis results, which may result in a relatively large cost in time and increased processing time.

### SUMMARY

The inventive concepts provide an electronic device with improved performance and reduced processing time, configured to tune an image signal processor, and a method of manufacturing the electronic device.

According to an aspect of the inventive concepts, there is provided a method of tuning an image signal processor by an electronic device. The method of tuning an image signal processor by an electronic device includes obtaining an image evaluation model, the image evaluation model configured to output an evaluation on an image received by the image evaluation model; determining key features of the image received by the image evaluation model based on the output the image evaluation model; determining a parameter list based on the key features; and training a tuning model based on the parameter list and the image evaluation model, the tuning model configured to output a parameter adjustment set based on an image received by the tuning model, and wherein the tuning model is a reinforcement learning model.

According to another aspect of the inventive concepts, there is provided an electronic device for training a tuning model. The electronic device includes at least one processor; and a memory storing instructions configured to, when execute by the at least one processor, cause the electronic device to obtain an image evaluation model configured to output an evaluation on an image received by the image evaluation model, determine key features of the image received by the image evaluation model based on the output of the image evaluation model, determine a parameter list based on the key features, and train a tuning model, based on the parameter list and the image evaluation model, the tuning model configured to output a parameter adjustment set based an image received by the tuning model.

According to another aspect of the inventive concepts, there is provided a computer-readable recording medium, having recorded thereon a program, configured to, when executed by at least one processor, cause a device to execute the method of claim 1.

### BRIEF DESCRIPTION OF THE DRAWINGS

Embodiments of the inventive concepts will be more clearly understood from the following detailed description taken in conjunction with the accompanying drawings in which:

FIG. 1 is a block diagram illustrating an example of tuning an image signal processor by a tuning system, according to at least one embodiment;

FIG. 2 is a diagram for describing examples of a preset according to at least one embodiment;

FIG. 3 is a block diagram illustrating an example of a method of operating the tuning system of FIG. 1;

FIG. 4 is a block diagram illustrating an electronic device according to at least one embodiment;

FIG. 5 is a block diagram showing the memory and the storage device of FIG. 4 in detail;

FIG. 6 is a flowchart of an example of a method of operating the profiling module of FIG. 5;

FIG. 7 is a block diagram illustrating the profiling module and storage device of FIG. 5 in detail;

FIG. 8 is a flowchart of an example of a method of operating the profiling module of FIG. 7;

FIG. 9 is a flowchart of operation S100 of FIG. 6 in detail;

FIG. 10 is a flowchart of operation S110 of FIG. 8 in detail;

FIGS. 11A and 11B are diagrams for describing a data analysis operation according to at least one embodiment;

FIG. 12 is a flowchart of operation S200 of FIG. 6 in detail;

FIG. 13 is a diagram for describing reinforcement learning;

FIG. 14 is a flowchart of operation S230 of FIG. 12 in detail;

FIGS. 15 and 16 are diagrams for describing a reinforcement learning operation of the reinforcement learning module of FIG. 7;

FIG. 17 is a flowchart of an example of a method of operating the tuning module of FIG. 5;

FIG. 18 is a flowchart of operation S330 of FIG. 17 in detail;

FIG. 19 is a diagram for describing a tuning operation of the tuning module of FIG. 5;

FIG. 20 is a diagram for describing a tuning operation of the tuning module of FIG. 5;

FIG. 21 is a diagram for describing a preset according to at least one embodiment; and

FIG. 22 is a block diagram illustrating a tuning system according to at least one embodiment.

### DETAILED DESCRIPTION OF THE EMBODIMENTS

Hereinafter, embodiments are described clearly and in detail to such an extent that a person skilled in the art can easily practice the inventive concepts.

When a part of a specification is said to “comprise” or “include” a component, this does not mean that it excludes other components, but rather that it may include other components, unless otherwise stated. In addition, the terms “unit”, “model”, “processor”, and/or other terms describing a functional element configured to perform certain roles, used herein may be implemented and/or supported by processing circuitry such as, hardware, software, or a combination of hardware and software. For example, the processing circuitry may include, but is not limited to, a central processing unit (CPU), an application processor (AP), an arithmetic logic unit (ALU), a graphic processing unit (GPU), a digital signal processor, a microcomputer, a field programmable gate array (FPGA), a System-on-Chip (SoC) a programmable logic unit, a microprocessor, or an application-specific integrated circuit (ASIC), etc. However, such terms are not limited to software or hardware. For example, the terms “unit” and/or “module” may be configured to reside on an addressable storage medium and may be configured to reproduce one or more functional elements (e.g., processors). Thus, as an example, a “unit” or “module” may include components such as software components, object-oriented software components, class components, and task components, and processes, functions, attributes, procedures, subroutines, segments of program code, drivers, firmware, microcode, circuitry, data, databases, data structures, tables, arrays, and variables. The functionality provided within the components and “units” may be combined into a smaller number of components and “units” or further separated into additional components and “units”.

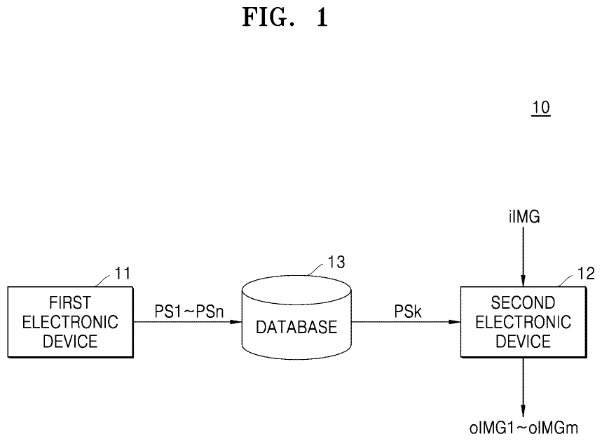

FIG. 1 is a block diagram illustrating an example of tuning an image signal processor (ISP) by a tuning system 10, according to at least one embodiment.

Referring to FIG. 1, the tuning system 10 according to at least one embodiment may include a first electronic device 11, a second electronic device 12, and a database 13. The tuning system 10 may tune the ISP. The tuning system 10 may generate an optimal set of parameters to be applied to the ISP. Tuning may refer to an operation of improving (hereafter ‘optimizing’) and/or adjusting an ISP. In other words, the tuning may refer to an operation of optimizing and adjusting an ISP based on a plurality of parameter values input to the ISP.

The tuning system 10 is configured to provide a plurality of output images. The tuning system 10 may, for example, provide a plurality of output images to a user. For example, the tuning system 10 may generate a plurality of output images so that the user may directly select an image from among the plurality of output images. The tuning system 10 may apply a set of parameters corresponding to a determined output image to the ISP.

The first electronic device 11 is configured to generate a plurality of preset tuning parameters and instructions (hereafter ‘presets’) PS1 to PSn. In at least some embodiments, the instructions may be provided as models configured to receive image data as an input and to generate an output based on the received data. In some embodiments, the models may be, for example, enabled by artificial intelligence, an artificial neural network, a decision tree, a support vector machine, a Bayesian network, a genetic algorithm, and/or the like. The first electronic device 11 may generate a plurality of types of presets PS. In at least one embodiment, the first electronic device 11 may generate a first type preset T1_PS and a second type preset T2_PS. Each of the plurality of presets PS1 to PSn may have either the first type or the second type. Each of the plurality of presets PS1 to PSn may be either the first type preset T1_PS or the second type preset T2_PS.

In at least one embodiment, as described in further detail below, the first type preset T1_PS may include a tuning model TM and a parameter list PL. The second type preset T2_PS may include an image quality assessment (IQA) model IM (hereinafter, referred to as “IQA model”) and the parameter list PL.

In at least one embodiment, the first electronic device 11 may transmit the plurality of presets PS1 to PSn to the database 13. The first electronic device 11 may store the plurality of presets PS1 to PSn to the database 13.

In at least one embodiment, the second electronic device 12 may obtain a preset PSk from the database 13. The second electronic device 12 may receive the preset PSk from the database 13. In at least one embodiment, the second electronic device 12 may obtain at least one (e.g., a kth preset PSk) of the first to n^{th} presets PS1 to PSn stored in the database 13.

In at least one embodiment, the k^{th} preset PSk may be one of the first type preset T1_PS or the second type preset T2_PS. The second electronic device 12 may receive an input image iIMG. The second electronic device 12 may generate an optimal parameter set based on the preset PSk. The second electronic device 12 may generate optimal output images oIMG1 to oIMGm based on the preset PSk by performing signal processing on the input image iIMG.

For example, the first electronic device 11 may be a server. The second electronic device 12 may be a smartphone, a tablet personal computer (PC), a PC, a smart television (TV), a mobile phone, a personal digital assistant (PDA), a laptop, a media player, a micro server, a global positioning system (GPS) device, an electronic book terminal, a terminal for digital broadcasting, a navigation, a kiosk, an MP3 player, a digital camera, a home appliance, and other mobile or non-mobile computing devices including an image display, but is not limited thereto. In addition, the second electronic device 12 may be a wearable device such as a watch, glasses, hair band, or ring having a communication function and a data processing function.

In comparative examples, wherein tuning of the ISP employs a method depending on the human evaluation, and objective and accurate tuning may be difficult. According to at least one embodiment, the tuning system 10 may generate the tuning model TM and the parameter list PL by performing a data analysis operation. The tuning system 10 may generate a plurality of output images and a plurality of parameter sets by performing a tuning operation based on the tuning model TM and the parameter list PL. The tuning system 10 may apply the tuned parameter set to the ISP so that the performance of the ISP may be improved. In addition, by tuning the ISP considering the user's image quality preference, an optimal resulting image may be provided to the user.

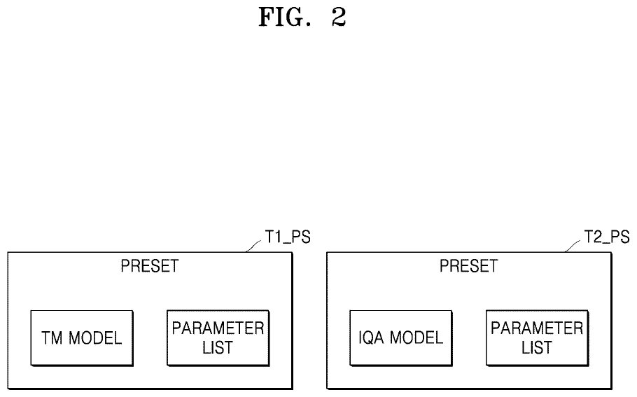

FIG. 2 is a diagram for describing examples of the preset PS according to an embodiment.

Referring to FIGS. 1 and 2, the tuning system 10 may generate the preset PS. The tuning system 10 may generate a plurality of types of presets PS. For example, the preset PS may have a first type or second type. The first type preset T1_PS may include the tuning model TM and the parameter list PL. The tuning system 10 may generate the first type preset T1_PS by performing both a data analysis operation and a reinforcement learning operation. For example, the first type preset T1_PS may be used to tune a user-shot video or image to a desired level.

The second type preset T2_PS may include an IQA model and the parameter list PL. The tuning system 10 may generate the second type preset T2_PS by performing only the data analysis operation. For example, the second type preset T2_PS may be used to directly generate the tuning model TM based on a training data set in which a user preference is reflected.

For example, in at least one embodiment, the IQA model IM may be used to output an evaluation on an image. For example, the IQA model IM may generate an evaluation on the image. For example, a tuning direction may be determined through the IQA model IM. The first electronic device 11 may obtain an evaluation for each image (or video) feature through the IQA model IM. The first electronic device 11 may determine the tuning direction by analyzing the evaluation.

In at least one embodiment, the parameter list PL may include key parameters. The parameter list PL may include parameters to be tuned (or have their values adjusted). In some embodiments, the parameter list PL may include identifiers of parameters. Parameters included in the parameter list PL may be determined based on a result (or evaluation or evaluation data) of the IQA model IM. For example, key features of an image may be determined by analyzing the IQA model IM. The key image features may be selected by interpreting the result of the IQA model IM. The key ss may be determined based on the evaluation, which is the output of the IQA model IM. For example, the key image features may include noise, color, edge, polygon, texture, saturation, brightness, color gamut, tone, blur, sharpness, contrast, and the like. However, the inventive concepts are not limited thereto.

In at least one embodiment, the parameters included in the parameter list PL may be determined based on the key features of the image. The parameters included in the parameter list PL may be parameters corresponding to the key features of the image.

In at least one embodiment, the tuning model TM may be a reinforcement learning model. The tuning model may receive an image and output a parameter adjustment set PAS. The tuning model may generate the parameter adjustment set PAS based on the image. The parameter adjustment set PAS may include a plurality of entries. The entries may include a parameter identifier and a parameter adjustment amount. The parameter adjustment amount may indicate an adjustment amount (or change amount) of a value corresponding to the parameter identifier. The parameter adjustment set may include adjustment amounts for a plurality of parameters. For example, the parameter adjustment set may include adjustment amounts for the parameters included in the parameter list. Alternatively, the parameter adjustment set may include adjustment amounts for at least one of the parameters included in the parameter list.

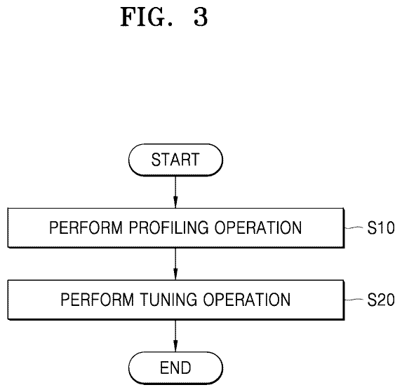

FIG. 3 is a block diagram illustrating an example of a method of operating the tuning system 10 of FIG. 1.

Referring to FIGS. 1 and 3, the tuning system 10 may generate a parameter set for image quality optimization. The tuning system 10 may generate an output image by applying an optimal parameter set to the ISP. In operation S10, the tuning system 10 may perform a profiling operation. The profiling operation may refer to an operation of generates a preset including a model and a parameter list. The tuning system 10 may generate the first type preset T1_PS and/or the second type preset T2_PS. The tuning system 10 may perform a profiling operation and prepare a model and parameter list to be used in the tuning operation.

In at least one embodiment, the tuning system 10 may generate an evaluation on the image by using the IQA model IM, which is an artificial intelligence model. The IQA model IM may be an artificial intelligence model trained to receive an image and output an evaluation on the image. The IQA model IM may be implemented by using a deep neural network architecture and/or algorithm, and/or through variations of various known deep neural network architectures and algorithms.

In operation S20, the tuning system 10 may perform a tuning operation. The tuning system 10 may perform the tuning operation based on the preset PS. The tuning operation may refer to an operation of generating an optimal parameter set for the ISP, and generating an output image by applying the optimal parameter set to the ISP.

In at least one embodiment, the tuning system 10 may generate the tuned parameter set and an output image with optimized image quality for an image by using the tuning system 10, which is an artificial intelligence model. The tuning model TM may be an artificial intelligence model trained to receive an image and output the parameter adjustment set PAS. The tuning model TM may be implemented by using various known deep neural network architectures and algorithms, or through variations of various known deep neural network architectures and algorithms.

As described above, the tuning system 10 may perform the profiling operation and the tuning operation. The tuning system 10 may generate optimal parameter sets and a plurality of output images. Accordingly, at least a part of the ISP may be automatically tuned and a tuning time of the ISP may be reduced. The tuning operation according to at least one embodiment may be performed on the ISP to suit the preferences of non-expert users by considering user preferences; and, thereby, the tuning system 10 may provide an image in which the user preferences are reflected.

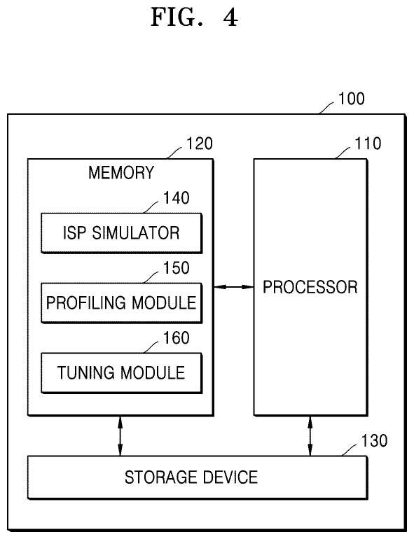

FIG. 4 is a block diagram illustrating the electronic device 100 according to at least one embodiment.

Referring to FIGS. 1 and 4, an electronic device 100 may include at least one processor 110, a memory 120, and a storage device 130. The electronic device 100 may correspond to the first electronic device 11 and the second electronic device 12 of FIG. 1. The first electronic device 11 of FIG. 1 may be identical or substantially similar to the electronic device 100. Additionally, the second electronic device 12 of FIG. 1 may be identical or substantially similar to the electronic device 100. The memory 120 may include an ISP simulator 140, a profiling module 150, and a tuning module 160.

In at least one embodiment, the electronic device 100 may tune an ISP. For example, the electronic device 100 may generate an optimal parameter set, and apply the optimal parameter set to the ISP. The electronic device 100 may perform signal processing on an input image by using the optimal parameter set and generate an output image. The electronic device 100 may perform image quality optimization.

The memory 120 may store various data, programs, or applications for driving and controlling the electronic device 100. A program stored in the memory 120 may include one or more instructions. The program (one or more instructions) or applications stored in the memory 120 may be executed by a processor 110.

The memory 120 according to at least one embodiment may include one or more instructions constituting a neural network. In addition, the memory 120 may include one or more instructions for controlling a neural network. The neural network may include a plurality of layers including one or more instructions to generate, from an image, an evaluation on the input image, and a plurality of layers including one or more instructions to generate the parameter adjustment set PAS from the input image.

In at least one embodiment, the memory 120 may include non-volatile memory including at least one of flash memory type memory hard disk type memory, multimedia card micro type memory, card type memory (e.g., secure digital (SD) or extreme digital (XD) memory), read-only memory (ROM), electrically erasable programmable ROM (EEPROM), programmable ROM (PROM), magnetic memory, a magnetic disk, an optical disk, etc. and volatile memory such as random access memory (RAM), static RAM (SRAM), and/or the like.

In at least one embodiment, the memory 120 stores one or more instructions and/or programs that, when executed by a processor (e.g., the processor 110) cause the electronic device 100 to perform a profiling operation and a tuning operation. For example, the memory 120 may store the profiling module 150 and the tuning module 160. Meanwhile, the modules stored in the memory 120 described above are for convenience of description, and the inventive concepts are not limited thereto. Other modules may be added to implement the embodiment described above, and some of the modules described herein may be implemented as a single module.

In at least one embodiment, the memory 120 of the electronic device 100 may store both the profiling module 150 and the tuning module 160. The processor 110 of the electronic device 100 may execute the profiling module 150 and perform a profiling operation. The processor 110 of the electronic device 100 may execute the tuning module 160 and perform a tuning operation. As described above, both the profiling operation and the tuning operation may be performed in one electronic device 100. However, the inventive concepts are not limited thereto.

In at least one embodiment, the profiling module may be stored in a memory of the first electronic device, and the tuning module may be stored in a memory of the second electronic device, which is different from the first electronic device. Accordingly, a processor of the first electronic device may execute the profiling module and perform the profiling operation. A processor of the second electronic device may execute the tuning module and perform the tuning operation. An electronic device in which the profiling operation is performed and an electronic device in which the tuning operation is performed may be different from each other.

The electronic device 100 may include the at least one processor 110. The processor 110 may be configured to control overall operations of the electronic device 100. For example, the processor 110 may execute one or more instructions of a program stored in the memory 120 to control overall operations for the electronic device 100 to perform the profiling operation and the tuning operation.

The processor 110 may be one or more processors. The one or more processors 110 according to the inventive concepts may include at least one of a central processing unit (CPU), a graphics processing unit (GPU), an accelerated processing unit (APU), a many integrated core (MIC), a digital signal processor (DSP), a neural processing unit (NPU), and/or the like. The one or more processors 110 may be implemented in the form of an integrated system-on-chip (SoC) including one or more electronic components. Each of the one or more processors may be implemented as separate hardware (H/W).

The processor 110 may execute the ISP simulator 140 to generate an output image for an input image. The ISP simulator 140 may be software for performing an ISP function. The ISP simulator 140 may receive a parameter set from the tuning module 160. The ISP simulator 140 may store the parameter set in a register of the ISP simulator 140. The ISP simulator 140 may obtain an input image, perform image signal processing on the input image by using the parameter set, and generate an output image. For example, the image signal processing may include bad pixel correction, noise reduction, lens shading correction, color correction, gamma (or gamma curve) correction, sharpness enhancement, auto exposure correction, auto focus correction, and/or auto white balance correction.

In at least one embodiment, the electronic device 100 may include an ISP (not shown). For example, the electronic device 100 may include the ISP instead of and/or in addition to the ISP simulator 140. The ISP may perform operations of the ISP simulator 140 described below. For example, the ISP may receive a parameter set. The ISP may store the parameter set in a register of the ISP. The ISP may perform image signal processing on the input image based on the parameter set to generate an output image. The electronic device 100 may perform a profiling operation and/or a tuning operation by using the ISP or ISP simulator 140.

Depending on the performance or tuning method of the ISP, different result images may be generated from the same raw image. An optimal result image may be provided to the user by precisely tuning the ISP.

In at least one embodiment, the ISP may receive an image from an image sensor (not shown) included in the electronic device 100, and perform various signal processing operations on the received image data. For example, the ISP may perform various signal processing such as noise canceling, white balancing, gamma correction, color gamut, or color conversion on the received image. The signal-processed image may be transmitted to an external device (e.g., a display device) or stored in a separate storage device.

The processor 110 may execute the profiling module 150 and perform a profiling operation. In at least one embodiment, the profiling module 150 may include the IQA model IM and the tuning model TM, which are artificial intelligence models. However, the inventive concepts are not limited thereto. For example, the IQA model IM may not be an artificial intelligence model. A configuration and operations of the profiling module 150 are described below in greater detail with reference to the drawings.

The processor 110 may execute the tuning module 160 and perform a tuning operation. The tuning module 160 may include the tuning model TM and the IQA model IM, which are artificial intelligence models. However, the inventive concepts are not limited thereto. For example, the IQA model IM may not be an artificial intelligence model. A configuration and operations of the tuning module 160 are described below in greater detail with reference to the drawings.

The processor 110 according to at least one embodiment may obtain an image. For example, the processor 110 may execute a photo album application or the like and read an image stored in the memory 120. Alternatively, the processor 110 may receive an image from an external server (e.g., a social network service (SNS) server, a cloud server, or content providing server) through a communication unit (not shown). Alternatively, the processor 110 may obtain a preview image and a capture image through a camera unit (not shown).

The processor 110 according to at least one embodiment may generate an evaluation on an image by using instructions constituting a neural network stored in the memory, and generate the parameter adjustment set PAS corresponding to the image. Through this, the processor 110 may tune the ISP and optimize the image quality. The processor 110 may control the memory 120 or storage device 130 to store the output image and the parameter set.

The storage device 130 may store data regardless of power supply. For example, the storage device 130 may include at least one of various non-volatile memory, such as flash memory, phase change RAM (PRAM), magnetic RAM (MRAM), resistive RAM (ReRAM), and ferroelectric RAM (FRAM). For example, the storage device 130 may include built-in memory and/or removable memory of the electronic device 100. In at least one embodiment, a database may be established on the storage device 130. A plurality of presets PS may be stored in the storage device 130. A training data set may be stored in the storage device 130.

In at least one embodiment, the electronic device 100 may further include a display unit (not shown). The display unit may display information processed by the processor 110, under the control by the processor 110. The display unit may output image data processed by the processor 110 to a screen of the electronic device 100.

As described above, the electronic device 100 may provide a tuned output image in which user preferences are reflected. The electronic device 100 may thereby improve the image quality based on the user's preferences.

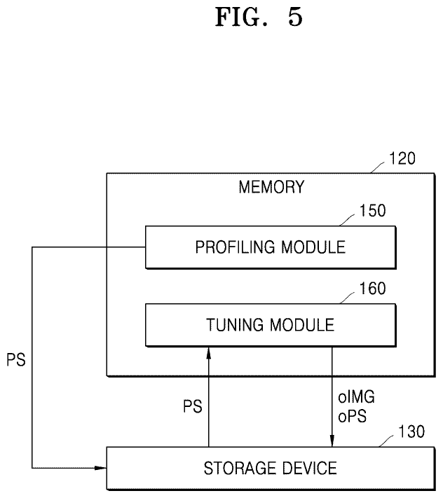

FIG. 5 is a block diagram showing the memory 120 and the storage device 130 of FIG. 4 in detail.

Referring to FIGS. 4 and 5, the memory 120 may include the profiling module 150 and the tuning module 160. The profiling module 150 may perform a profiling operation. The profiling module 150 may generate the preset PS. The profiling module 150 may transmit the preset PS to the storage device 130. The profiling module 150 may store the preset PS in the storage device 130. Alternatively, the profiling module 150 may store the preset PS in a database (not shown).

The tuning module 160 may perform a tuning operation. The tuning module 160 may obtain the preset PS. In at least one embodiment, the tuning module 160 may receive the preset PS from the storage device 130. Alternatively, the tuning module 160 may receive the preset PS from the database. Alternatively, the tuning module 160 may receive the preset PS from the profiling module 150. The tuning module 160 may generate an output parameter set oPS and an output image oIMG by performing the tuning operation. The tuning module 160 may transmit the output parameter set oPS and the output image oIMG to the storage device 130. The tuning module 160 may store the output parameter set oPS and the output image oIMG in the storage device 130 (or database).

In at least some embodiments, the memory 120 may include processing circuitry enabling the tuning module 160 and/or the profiling module 150 and/or may communicate with one or more processors (e.g., processor 110) with the one or more processors enabling the tuning module 160 and/or the profiling module 150. Additionally, in at least some embodiments, the memory 120 may communicate with the storage device 130 through, e.g., a bus and/or other communication hardware, and/or through a connection including the one or more processors.

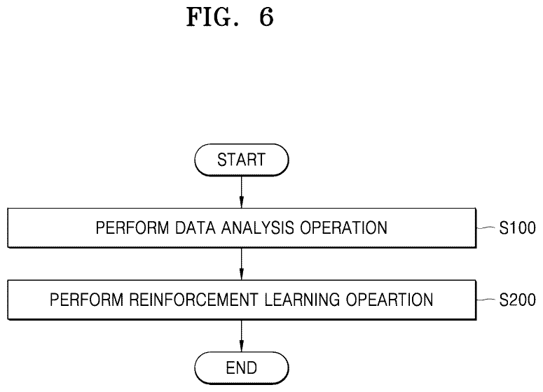

FIG. 6 is a flowchart of an example of a method of operating the profiling module 150 of FIG. 5.

Referring to FIGS. 3, 5, and 6, operation S10 of FIG. 3 may include operations S100 and S200. The profiling operation may include a data analysis operation and a reinforcement learning operation. The profiling module 150 may generate a preset by performing the profiling operation.

In operation S100, the profiling module 150 may perform the data analysis operation. The profiling module 150 may perform the data analysis operation and generate the IQA model IM and a parameter list. For example, the profiling module 150 may search for the IQA model IM that may well represent current image results by using a machine learning-based data analysis technique, and select parameters to be tuned by using prior knowledge of an expert. Accordingly, an IQA model generation time may be reduced.

In operation S200, the profiling module 150 may perform the reinforcement learning operation. For example, the profiling module 150 may find an improved (or optimal) tuning model TM by applying the results of the data analysis operation to reinforcement learning. The profiling module 150 may evaluate an image by using the IQA model IM, and perform reinforcement learning on the tuning model TM in a direction of increasing an evaluation (or evaluation score) output from the IQA model IM.

In at least one embodiment, the profiling module 150 may perform both operations of $100 and S200. In this case, the profiling module 150 may generate the first type preset T1_PS. The profiling module 150 may store the first type preset T1_PS in the storage device 130. The tuning module 160 may perform a first tuning operation. The first tuning operation may refer to a tuning operation performed when the first type preset T1_PS is received. The first tuning operation may refer to an operation of generating an optimal parameter set and an output image by using the trained tuning model TM.

In at least one embodiment, the profiling module 150 may perform only operation S100 and not perform operation S200. In other words, operation S200 may be omitted. In this case, the profiling module 150 may generate the second type preset T2_PS. The profiling module 150 may store the second type preset T2_PS in the storage device 130. The tuning module 160 may perform a second tuning operation. The second tuning operation may refer to a tuning operation performed when the second type preset T2_PS is received. The second tuning operation may refer to an operation of training the tuning model TM based on the IQA model IM, and generating an optimal parameter set and an output image by using the trained tuning model TM.

As described above, the profiling module 150 may perform the data analysis operation and generate the IQA model IM and the parameter list PL. The profiling module 150 may train the tuning model TM by performing the reinforcement learning operation.

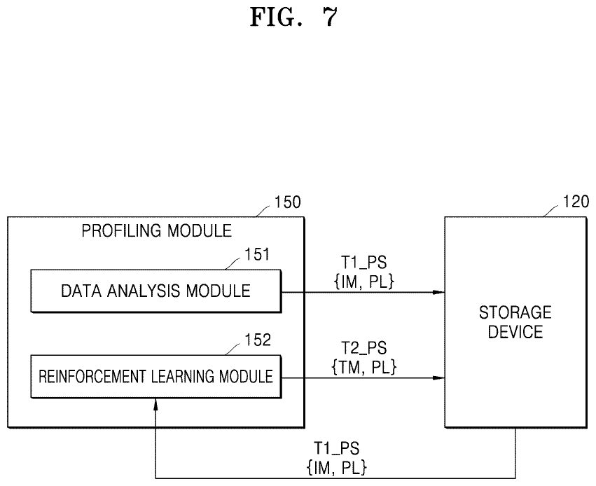

FIG. 7 is a block diagram illustrating the profiling module 150 and storage device 130 of FIG. 5 in detail.

Referring to FIGS. 5 and 7, the profiling module 150 may include a data analysis module 151 and a reinforcement learning module 152. The data analysis module 151 may perform a data analysis operation. The data analysis module 151 may generate the second type preset T2_PS. The data analysis module 151 may transmit the second type preset T2_PS to the storage device 130. The data analysis module 151 may store the second type preset T2_PS in the storage device 130.

The reinforcement learning module 152 may perform a reinforcement learning operation. The reinforcement learning module 152 may obtain the IQA model IM and the parameter list PL. In at least one embodiment, the reinforcement learning module 152 may receive the second type preset T2_PS rom the storage device 130. The reinforcement learning module 152 may load the IQA model IM and the parameter list PL from the storage device 130. In at least one embodiment, the reinforcement learning module 152 may directly receive the IQA model IM and the parameter list PL from the data analysis module 151.

The reinforcement learning module 152 may generate the first type preset T1_PS. The reinforcement learning module 152 may transmit the first type preset T1_PS to the storage device 130. The reinforcement learning module 152 may store the first type preset T1_PS in the storage device 130.

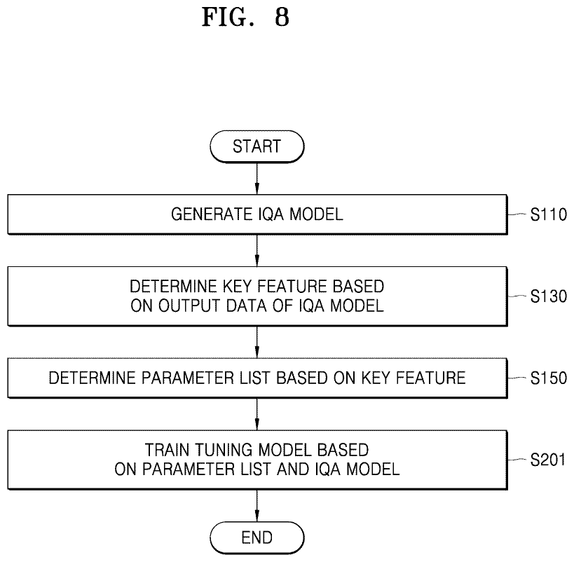

FIG. 8 is a flowchart of an example of a method of operating the profiling module 150 of FIG. 7.

Referring to FIGS. 6, 7, and 8, operation S100 of FIG. 6 may include operations S110 to S150. Operation S200 of FIG. 6 may include operation S201. In operation S110, the profiling module 150 may generate the IQA model IM. The profiling module 150 may perform an IQA model generation operation. The profiling module 150 may receive an image and generate the IQA model IM for outputting an evaluation on the image using the received image. In at least one embodiment, the profiling module 150 may generate the IQA model IM by using interpretable low-level statistical data. The profiling module 150 may generate the IQA model IM through data analysis quickly compared to the comparative example.

In at least one embodiment, the profiling module 150 may learn features of an image based on a deep network (or neural network), and derive interpretable results (e.g., evaluation contents) based on generative artificial intelligence (AI). The profiling module 150 may generate the IQA model IM that may generate an evaluation content for a current image level through image analysis.

In operation S130, the profiling module 150 may determine key features based on output data of the IQA model IM. The output data of the IQA model IM may refer to modeling results. The IQA model IM may receive an image and output an evaluation on the image. The output data of the IQA model IM may be an evaluation on the image. For example, the output data of the IQA model IM may include an evaluation score or evaluation content for the image. The IQA model IM may generate output data based on training data. The IQA model IM may include output data including an evaluation for the training data. The profiling module 150 may determine key features based on output data of the IQA model IM. The profiling module 150 may analyze the output data and determine key features.

In operation S150, the profiling module 150 may determine a parameter list based on the key features. For example, the profiling module 150 may generate a parameter list. The parameter list may include parameters to be tuned. In at least one embodiment, the profiling module 150 may determine parameters to be tuned based on the output data (e.g., evaluation) of the IQA model IM. The profiling module 150 may include parameters corresponding to the key features in the parameter list.

In at least one embodiment, the profiling module 150 may not perform reinforcement learning on parameters of all ISPs. The profiling module 150 may train the tuning model TM by performing reinforcement learning on some of many parameters. Accordingly, the profiling module 150 may reduce a training time of the tuning model.

In at least one embodiment, the parameter list may be selected by using prior knowledge of an expert. Accordingly, in the tuning system 10 according to at least one embodiment, collaboration between image quality experts and engineers.

In operation S201, the tuning model TM may be trained based on the parameter list PL and the IQA model IM. The profiling module 150 may train the tuning model TM by performing reinforcement learning. The profiling module 150 may determine the optimal tuning model TM by applying data analysis results to reinforcement learning. The profiling module 150 may train the tuning model TM based on the IQA model IM and the parameter list PL generated through the data analysis operation.

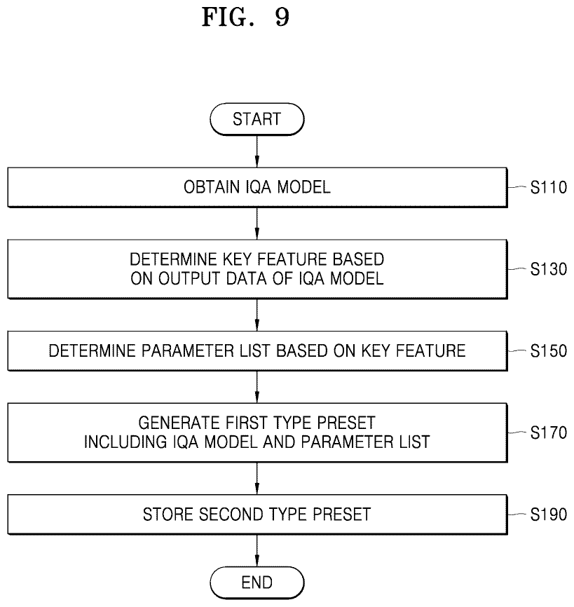

FIG. 9 is a flowchart of operation S100 of FIG. 6 in detail.

Referring to FIGS. 6, 7, and 9, the profiling module 150 may perform a data analysis operation. Operation S100 of FIG. 6 may include operations S110 to S190.

In operation S110, the profiling module 150 may generate the IQA model IM. In operation S130, the profiling module 150 may determine key features based on output data of the IQA model IM. In operation S150, the profiling module 150 may determine a parameter list based on the key features. Operations S110 to S150 of FIG. 9 are identical to (or substantially similar to) operations S110 to S150 of FIG. 8, and thus detailed descriptions thereof are omitted.

In operation S170, the profiling module 150 may generate the second type preset T2_PS including the IQA model IM and the parameter list PL. In at least one embodiment, when the IQA model IM is trained by using a neural network, the second type preset T2_PS may include the trained IQA model IM and the parameter list PL.

In operation S190, the profiling module 150 may store the second type preset T2_PS in the storage device 130. Alternatively, the profiling module 150 may store the second type preset T2_PS in a memory of a server connected to the electronic device 100 via a wired or wireless network. Alternatively, the profiling module 150 may store the second type preset T2_PS in a database.

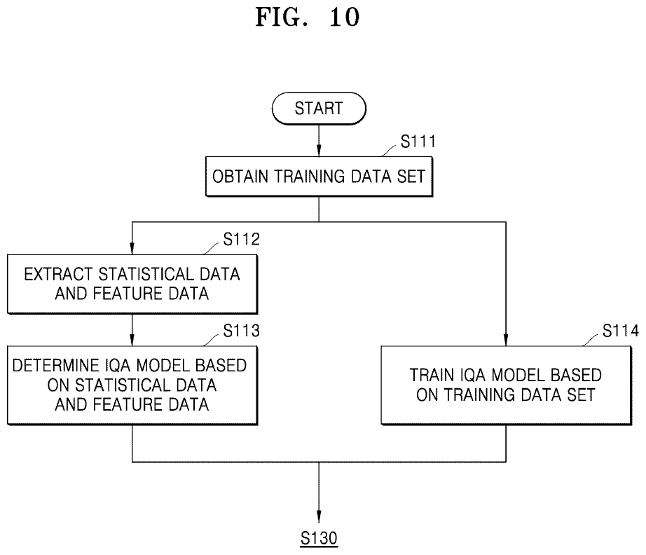

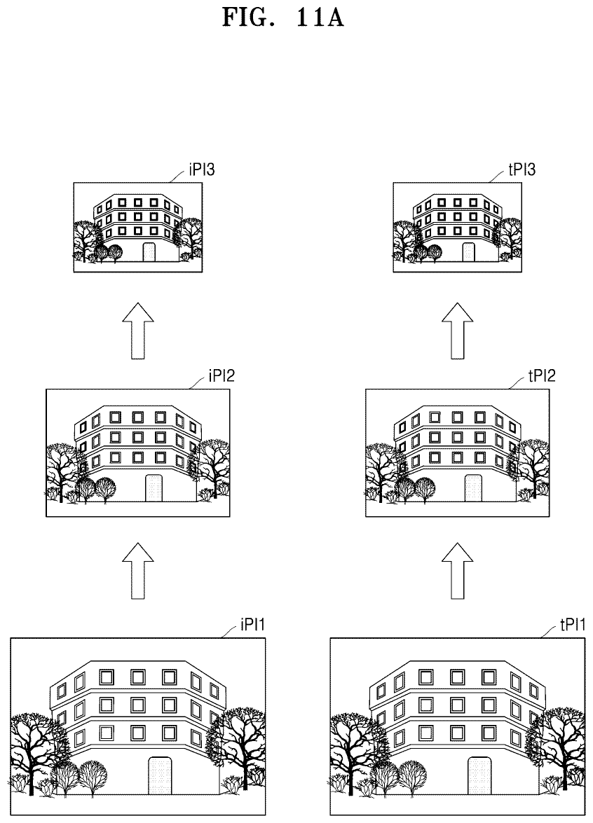

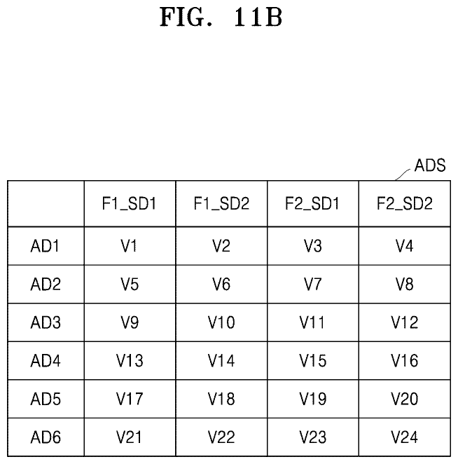

FIG. 10 is a flowchart of operation S110 of FIG. 8 in detail. FIGS. 11A and 11B are diagrams for describing a data analysis operation according to at least one embodiment.

Referring to FIGS. 7, 9, 10, 11A, and 11B, the profiling module 150 may perform an IQA model generation operation. The profiling module 150 may generate the IQA model IM.

In operation S111, the profiling module 150 may obtain a training data set. The training data set may include a plurality of training data. The training data may include a sample image, a target image, and a reference image. In at least one embodiment, the profiling module 150 may generate the IQA model IM based on the training data set. The training data set may be a large data set that may well represent features of an image. The training data set may include data with sufficient diversity so that the IQA model IM may accurately perform evaluation based on the features of the image.

The profiling module 150 may perform either operation S112 or operation S114. In at least some embodiments, the profiling module 150 may select between operation S112 or operation S114 based on, e.g., a command and/or condition in the data training set. In at least one embodiment, the profiling module 150 may generate the IQA model IM by performing operations S112 and S113. For example, the profiling module 150 may generate the IQA model IM based on data analysis. In other words, the profiling module 150 may select the IQA model IM based on an analysis data set.

In at least one embodiment, the profiling module 150 may generate the IQA model IM by performing operation S114. The profiling module 150 may generate the IQA model IM based on a neural network and generative AI.

In operation S112, the profiling module 150 may extract statistical data and feature data of an image. The profiling module 150 may extract the statistical data of the image. For example, the statistical data may be basic statistics. The statistical data may include data such as mean, standard deviation, minimum/maximum, root mean square, first derivative, and second derivative. The profiling module 150 may extract the feature data. For example, the feature data of the image may include noise, color, edge, polygon, texture, saturation, brightness, color gamut, tone, blur, sharpness, contrast, and the like. However, the inventive concepts are not limited thereto.

In at least one embodiment, the profiling module 150 may extract statistical data and feature data based on a training data set. The profiling module 150 may extract statistical data and feature data of each of a plurality of training data. The profiling module 150 may extract statistical data and feature data of each of a sample image, a target image, and a reference image.

In at least one embodiment, the profiling module 150 may decompose the image into a pyramid structure. The profiling module 150 may generate at least one pyramid image by downsampling an image. The profiling module 150 may extract statistical data or feature data based on the pyramid image. Herein, a structure of hierarchically extracting statistical data or feature data based on a plurality of pyramid images having different solutions and generated by downsampling one image data as described above may be referred to as a pyramid structure. For example, the profiling module 150 may generate sample pyramid images sPI1 to sP13 with respect to a sample image. The profiling module 150 may extract statistical data and feature data from the sample pyramid images sPI1 to sPI3. The profiling module 150 may also generate target pyramid images tPI1 to tPI3 with respect to a target image. The profiling module 150 may extract statistical data and feature data from the target pyramid images tPI1 to tPI3.

For example, the profiling module 150 may generate the first to third sample pyramid images sPI1 to sPI3 with respect to the sample image. The profiling module 150 may generate the first sample pyramid image sPI1 having a first resolution based on the sample image. The profiling module 150 may generate the second sample pyramid image sPI2 having a second resolution by downsampling the first sample pyramid image sPI1. The profiling module 150 may generate the third sample pyramid image sPI3 having a third resolution by downsampling the second sample pyramid image sPI2. The profiling module 150 may perform downsampling based on a predetermined integer ratio, and in at least one embodiment, the profiling module 150 may perform downsampling by multiplying a resolution of the original image by half (½) or by

$$\frac{1}{\sqrt{2}}$$

times.

The profiling module 150 may generate the first to third target pyramid images tPI1 to tPI3 with respect to a target image. The profiling module 150 may generate the first target pyramid image tPI1 having a first resolution based on the target image. The profiling module 150 may generate the second target pyramid image tPI2 having a second resolution by downsampling the first target pyramid image tPI1. The profiling module 150 may generate the third target pyramid image tPI3 having a third resolution by downsampling the second target pyramid image tPI2. The profiling module 150 may perform downsampling based on a predetermined integer ratio, and in at least one embodiment, the profiling module 150 may perform downsampling by multiplying a resolution of the original image by half ( ) or by

$$\frac{1}{2} \qquad \frac{1}{\sqrt{2}}$$

times. The reference image is similar to the above, and redundant descriptions thereof are omitted.

In at least one embodiment, the profiling module 150 may extract statistical data and feature data. The profiling module 150 may extract statistical data for the first to third sample pyramid images sPI1 to sPI3. The profiling module 150 may extract statistical data for the first to third target pyramid images tPI1 to tPI3. For example, the profiling module 150 may extract first statistical data F1_SD1 having a first feature, second statistical data F1_SD2 having the first feature, first statistical data F2_SD1 having a second feature, and second statistical data F2_SD2 having a second feature. The first statistical data F1_SD1 having the first feature refers to an average of high-frequency noise, the second statistical data F1_SD2 having the first feature refers to a high-frequency standard deviation, the first statistical data F2_SD1 having the second feature refers to an average of low-frequency noise, and the second statistical data F2_SD2 having the second feature may refer to a standard deviation of low-frequency noise.

The profiling module 150 may generate an analysis data set ADS. For example, the analysis data set ADS may include a plurality of analysis data. The analysis data set ADS may include statistical data or feature data corresponding to each of a plurality of pyramid images. For example, the analysis data set ADS may include first to sixth analysis data AD1 to AD6. The first analysis data AD1 may correspond to the first sample pyramid image sPI1, the second analysis data AD2 may correspond to the second sample pyramid image sPI2, the third analysis data AD3 may correspond to the third sample pyramid image sPI3, the fourth analysis data AD4 may correspond to the first target pyramid image tPI1, the fifth analysis data AD5 may correspond to the second target pyramid image tPI2, and the sixth analysis data AD6 may correspond to the third target pyramid image tPI3.

For example, analysis data AD may include the first statistical data F1_SD1 having the first feature, the second statistical data F1_SD2 having the first feature, the first statistical data F2_SD1 having the second feature, and the second statistical data F2_SD2 having the second feature. The first analysis data AD1 may include first to fourth values V1 to V4. The second analysis data AD2 may include fifth to eighth values V5 to V8, the third analysis data AD3 may include ninth to twelfth values V9 to V12, the fourth analysis data AD4 may include 13^{th} to 16^{th} values V13 to V16, the fifth analysis data AD5 may include 17^{th} to 20^{th} values V17 to V20, and the sixth analysis data AD6 may include 21^{st} to 24^{th} values V21 to V24.

The first value V1 may correspond to the first statistical data F1_SD1 having the first feature, the second value V2 may correspond to the second statistical data F1_SD2 having the first feature of the first sample pyramid image sPI1, the third value V3 may correspond to the first statistical data F2_SD1 having the second feature of the first sample pyramid image sPI1, and the fourth value V4 may correspond to the second statistical data F2_SD2 having the second feature of the first sample pyramid image sPI1. The remaining values V5 to V24 are similar to the above, and redundant descriptions thereof are omitted.

In operation S113, the profiling module 150 may determine the IQA model IM based on statistical data and feature data. The profiling module 150 may determine the IQA model IM based on the statistical data and the feature data. The profiling module 150 may generate, based on the statistical data and the feature data, the IQA model IM trained to distinguish between an image and a target image.

In at least one embodiment, the profiling module 150 may determine the IQA model IM by comparing and analyzing statistical data and feature data of the sample image and statistical data and feature data of the target image. The profiling module 150 may generate the IQA model IM based on the analysis data set ADS. For example, the IQA model IM may be a regression model, a decision tree, a linear regression model, and/or the like.

In operation S114, the profiling module 150 may train the IQA model IM by using a neural network based on the training data set. The profiling module 150 may train, based on the sample image, a neural network that may generate scores and evaluation descriptions for detailed features. The IQA model IM may be a generative network based on a multi-model large language model. For example, the IQA model may be a deep learning model, a deep learning model based on a large language model, a generative artificial intelligence model, and/or the like.

The profiling module 150 may train the IQA model IM based on a training data set. In this case, the IQA model may be a pre-built model. For example, the IQA model may be a model pre-built by receiving a basic training data set.

The IQA model may be, for example, a model based on a neural network. For example, models such as deep neural network (DNN), recurrent neural network (RNN), and bidirectional recurrent DNN (BRDNN) may be used as IQA models, but the inventive concepts are not limited thereto.

In addition, the profiling module 150 may train the IQA model IM by using a training algorithm including, for example, error back-propagation or gradient descent.

In addition, the profiling module 150 may train the IQA model IM through supervised learning using, for example, a training data set for training determination criteria as input values. In addition, the profiling module 150 may train the IQA model IM through unsupervised learning, which finds determination criteria for quality evaluation of images by training itself by using data necessary for evaluating quality of images without any guidance, for example.

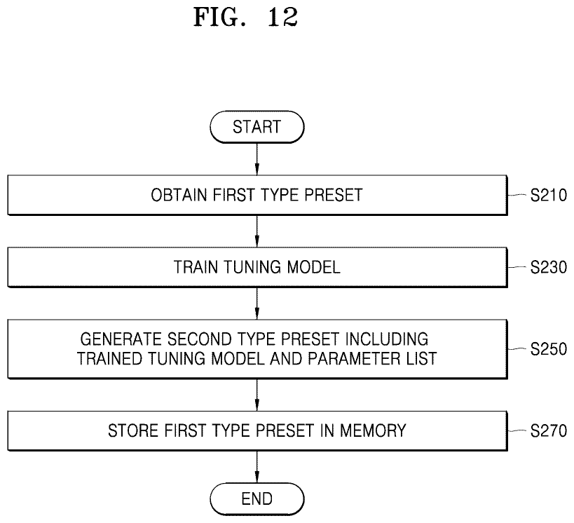

FIG. 12 is a flowchart of operation S200 of FIG. 6 in detail.

Referring to FIGS. 6, 7, and 12, the profiling module 150 may perform a reinforcement learning operation. The profiling module 150 may train the tuning model TM and generate the first type preset T1_PS including the trained tuning model TM and the parameter list PL. The profiling module 150 may store the first type preset T1_PS in the storage device 130.

In operation S210, the reinforcement learning module 152 may obtain the second type preset T2_PS. In at least one embodiment, the reinforcement learning module 152 may receive, from the memory 120, second type preset T2_PS including the IQA model IM and the parameter list PL. Alternatively, in at least one embodiment, the reinforcement learning module 152 may directly receive, from the data analysis module 151, the second type preset T2_PS including the IQA model IM and the parameter list PL.

In operation S230, the reinforcement learning module 152 may train the tuning model TM. The tuning model may be a reinforcement learning model. In operation S250, the reinforcement learning module 152 may generate the first type preset T1_PS including the trained tuning model TM and the parameter list PL. In operation S270, the reinforcement learning module 152 may store the first type preset T1_PS in the storage device 130. Alternatively, the reinforcement learning module 152 may store the first type preset T1_PS in a memory of a server connected to the electronic device 100 via a wired or wireless network. Alternatively, the reinforcement learning module 152 may store the first type preset T1_PS in a database.

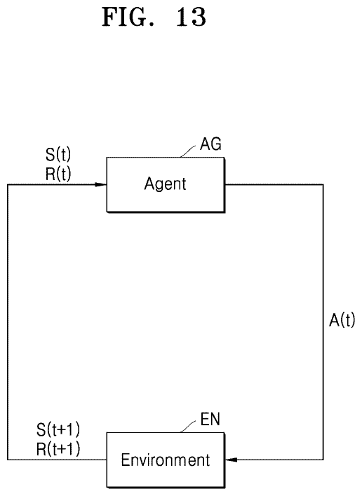

FIG. 13 is a diagram for describing reinforcement learning.

Reinforcement learning may refer to a learning technique for training to select an optimal action for a higher reward by continuously and repeatedly reflecting a state and reward that change according to an action selected by an agent AG in a given environment EN. The agent AG, which is subject to reinforcement learning, may refer to a subject or entity that acts in the environment EN. The environment EN, which is a background that interacts with the agent AG, may refer to a process that occurs through the interaction between the agent AG and the environment EN.

The agent AG may receive state variable S(t) and reward variables R(t) from the environment EN and provide action variables A(t) to the environment EN. The agent AG may be trained to provide an action corresponding to the maximum reward in a state in which the variables are received from the environment EN. The agent may be trained by updating a policy or by updating a quality (Q)-table. For example, the agent AG may include a Q-table and may be trained by updating the Q-table based on the reward variables R(t) received from the environment EN. The Q-table may include, for each combination of states and actions, a Q-value including the maximum value of immediate reward and future reward. The agent AG may provide the action variables A(t) to the environment EN. The environment EN may receive the action variables A(t) from the agent AG and provide a state and a reward to the agent AG. The environment EN may change the state variable S(t) by the action variables A(t), and generate reward variables R(t+1) based on the changed state variables S(t+1).

The state variable S(t) may include an initial state variable and first to t^{th} state variables, and the reward variables R(t) may include an initial reward variable and first to t^{th} reward variables. The action variables A(t) may include first to t^{th} action variables. Herein, the state variable S(t), the reward variables R(t), and the action variables A(t) may be referred to as a state, a reward, and an action, respectively.

For example, the agent AG may receive an initial state variable and an initial action variable from the environment EN and provide a first action variable to the environment EN. The agent AG may perform reinforcement learning based on the initial state variable and the initial action variable received from the environment EN. The agent AG may be trained to provide the action variables A(t) corresponding to the maximum reward variables R(t) from the state variable S(t). The agent AG may output the first action variable through reinforcement learning. The environment EN may receive the first action variable and change the initial state variable to the first state variable, and generate a first reward variable based on the changed first state variable.

The agent AG may determine the action variables A(t) according to the policy when the current state variable S(t) and reward variables R(t) are given from the environment EN. In addition, the environment EN may update the state variable S(t) to the next state variable S(t+1) according to the action variable A(t) determined by the agent AG, and determine a reward R(t+1) according to the updated state variable S(t+1). In some embodiments, the environment EN may generate a first state variable and a first reward variable based on a detected initial state S(0) and initial reward R(0). In addition, the agent AG may generate the action variable A(t) based on a state and reward provided from the environment EN.

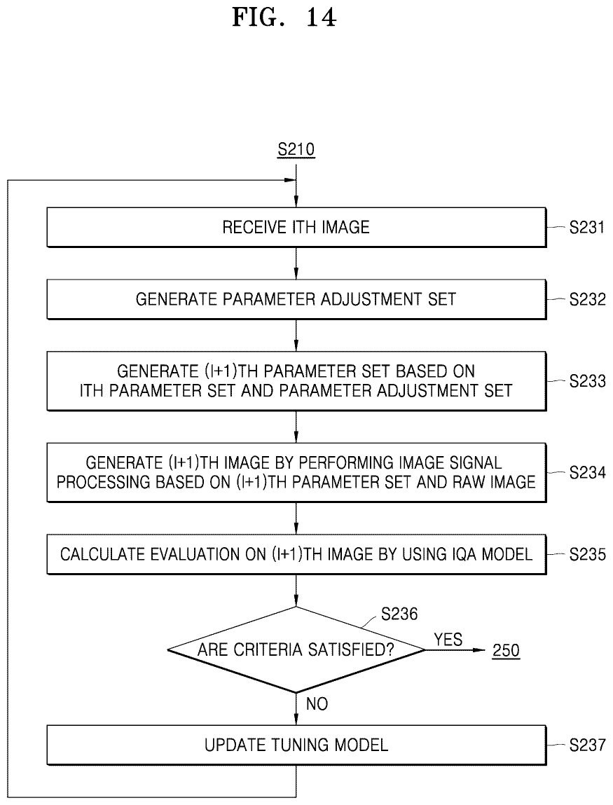

FIG. 14 is a flowchart of operation S230 of FIG. 12 in detail.

Referring to FIGS. 7, 12, and 14, the reinforcement learning module 152 may train the tuning model TM. Operation 230 of FIG. 12 may include operations S231 to S237. The tuning model TM may be the agent AG. A parameter generation module 153, the ISP simulator 140, and the IQA model IM may be included in the environment EN.

In operation S231, the reinforcement learning module 152 may receive an i^{th} image. Here, i may be a natural number. For example, the first image may be a sample image. The first image may be an initial state variable. The i^{th} image may correspond to the state variable S(t) of reinforcement learning.

In operation S232, the reinforcement learning module 152 may generate the parameter adjustment set PAS. The reinforcement learning module 152 may generate the parameter adjustment set PAS based on the i^{th} image. For example, the parameter adjustment set PAS may include parameter adjustment amounts. The parameter adjustment set PAS may include adjustment amounts of parameters included in the parameter list PL. The parameter adjustment set PAS may include unit step changes for each parameter. For example, the adjustment amount is a unit step and may refer to any of an increase, a decrease or maintenance. The parameter adjustment set PAS may correspond to the action variable A(t).

In operation S233, the reinforcement learning module 152 may generate an (i+1)^{th} parameter set based on an i^{th} parameter set and the parameter adjustment set PAS. The reinforcement learning module 152 may generate an (i+1)^{th} parameter set by adjusting parameter values of the i^{th} parameter set based on the parameter adjustment set PAS. The reinforcement learning module 152 may generate the (i+1)^{th} parameter set by combining the i^{th} parameter set and the parameter adjustment set PAS.

In operation S234, the reinforcement learning module 152 may generate an (i+1)^{th} image by performing image signal processing based on the (i+1)^{th} parameter set and a raw image. For example, the raw image may refer to a sample image corresponding to an initial state variable. The reinforcement learning module 152 may tune the ISP simulator 140 (or ISP) based on the (i+1)^{th} parameter set. The reinforcement learning module 152 may generate the (i+1)^{th} image through the tuned ISP simulator 140 (or ISP). The (i+1)^{th} image may correspond to a changed (or next) state variable S(t+1).

In operation S235, the reinforcement learning module 152 may produce an evaluation on the (i+1)^{th} image by using the IQA model IM. The evaluation may correspond to the reward variables R(t). In operation S236, the reinforcement learning module 152 may determine whether a tuning model satisfies criteria. Alternatively, the reinforcement learning module 152 may determine whether to terminate training of the tuning model. The reinforcement learning module 152 may re-train the tuning model TM when the trained tuning model does not satisfy certain criteria (e.g., is not within a preset tolerance). When the evaluation does not satisfy the certain criteria, the reinforcement learning module 152 may perform operation S237. The reinforcement learning module 152 may repeatedly perform operations S231 to S237 until the trained tuning model satisfies the certain criteria. The reinforcement learning module 152 may evaluate whether the trained tuning model satisfies the certain criteria and determine a model satisfying the certain criteria as a final tuning model. When the certain criteria are satisfied, the reinforcement learning module 152 may not perform operation S237. In other words, when the certain criteria are satisfied the reinforcement learning module 152 may no longer repeat operations S231 to S237 and the reinforcement learning module 152 may proceed to operation S250.

In operation S237, the reinforcement learning module 152 may update the tuning model TM. The reinforcement learning module 152 may update the tuning model TM based on an evaluation (or evaluation score) corresponding to the reward variable R(t). The reinforcement learning module 152 may update the policy or update the Q-table. Thereafter, the reinforcement learning module 152 may perform operation S231 again.

In at least one embodiment, when the trained tuning model does not satisfy the criteria, the reinforcement learning module 152 may repeat operations S231 to S237. In this case, the reinforcement learning module 152 may change the state variable S(t) to the (i+1)^{th} image.

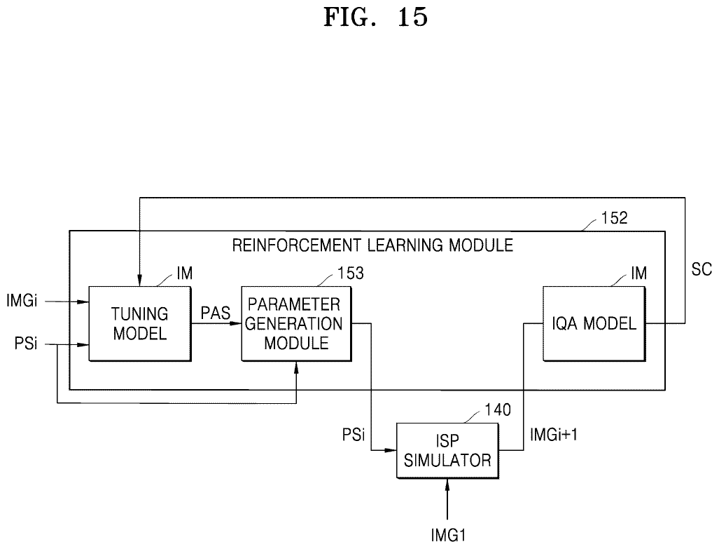

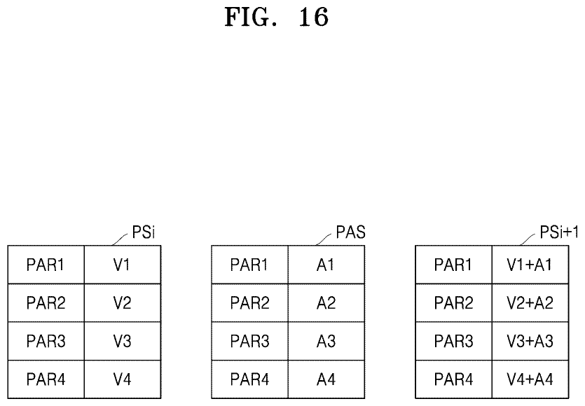

FIGS. 15 and 16 are diagrams for describing a reinforcement learning operation of the reinforcement learning module 152 of FIG. 7.

Referring to FIGS. 7 and 15, the reinforcement learning module 152 may perform a reinforcement learning operation. The reinforcement learning module 152 may include the parameter generation module 153. The parameter generation module 153 may generate the next parameter set (e.g., the (i+1)^{th} parameter set PSi+1) based on the parameter adjustment set PAS and a current parameter set (e.g., the i^{th} parameter set PSi). The parameter generation module 153 may generate the next parameter set (e.g., the (i+1)^{th} parameter set PSi+1) by combining the parameter adjustment set PAS and the current parameter set (e.g., the i^{th} parameter set PSi). The reinforcement learning module 152 may obtain the parameter list PL and the IQA model IM. The reinforcement learning module 152 may train the tuning model TM, which is a reinforcement learning model, based on the parameter list PL and the IQA model IM.

The reinforcement learning module 152 may train the tuning model TM used for training of an ISP by using training data. In this case, the tuning model may be a pre-built model. For example, the tuning model may be a model pre-built by receiving basic training data (e.g., a sample image or the like).

The tuning model may be, for example, a model based on a neural network. For example, models such as DNN, RNN, and BRDNN may be used as tuning models, but the inventive concepts are not limited thereto.

The reinforcement learning module 152 may train the tuning model TM through reinforcement learning using, for example, feedback regarding whether tuning of the ISP simulator 140 (or ISP) according to training is correct.

The tuning model TM may correspond to a reinforcement learning agent. The parameter generation module 153, the ISP simulator 140, and the IQA model IM may be included in a reinforcement learning environment. The tuning model TM may receive an i^{th} image IMGi corresponding to the state variable S(t). The tuning model TM may receive the i^{th} parameter set PSi. The i^{th} parameter set PSi may include values of parameters included in the parameter list PL.

Additionally, though the parameter list PL is described as including first to fourth parameters PAR1 to PAR4, the scope of the inventive concepts is not limited thereto, and depending on the implementation, the number of parameters included in the parameter list PL may be increased or reduced. The i^{th} parameter set PSi may include values of the respective first to fourth parameters PAR1 to PAR4. For example, the i^{th} parameter set PSi may include a value V1 of the first parameter PAR1, a value V2 of the second parameter PAR2, a value V3 of the third parameter PAR3, and a value V4 of the fourth parameter PAR4.

The tuning model TM may generate the parameter adjustment set PAS. The parameter adjustment set PAS may include an adjustment amount (or change amount) of parameters included in the parameter list PL. The tuning model TM may output the parameter adjustment set PAS. The parameter adjustment set PAS may correspond to the action variable A(t). For example, the tuning model TM may generate the parameter adjustment set PAS, which is the action variable A(t) corresponding to the maximum reward in a received state. For example, the parameter adjustment set PAS may include an adjustment amount A1 of the first parameter PAR1, an adjustment amount A2 of the second parameter PAR2, an adjustment amount A3 of the third parameter PAR3, and an adjustment amount A4 of the fourth parameter PAR4. For example, each of the adjustment amounts A1 to A4 may refer to any of “−1”, “0”, and “+1”, and/or the like.

The parameter generation module 153 may receive the i^{th} parameter set PSi and the parameter adjustment set PAS. The parameter generation module 153 may generate the (i+1)^{th} parameter set PSi+1 based on the i^{th} parameter set PSi and the parameter adjustment set PAS. The parameter generation module 153 may generate the (i+1)^{th} parameter set PSi+1 by performing an addition operation on the i^{th} parameter set PSi and the parameter adjustment set PAS. For example, the (i+1)^{th} parameter set PSi+1 may include a value V1+A1 of the first parameter PAR1, a value V2+A2 of the second parameter PAR2, a value V3+A3 of the third parameter PAR3, and a value V4+A4 of the fourth parameter PAR4. The parameter generation module 153 may provide the (i+1)^{th} parameter set PSi+1 to the ISP simulator 140.

The ISP simulator 140 may receive the (i+1)^{th} parameter set PSi+1. The ISP simulator 140 may receive a first image IMG1. For example, the first image IMG1 may be a raw image. The first image IMG1 may be an input image on which signal processing is not performed, or a sample image. The ISP simulator 140 may be tuned with the (i+1)^{th} parameter set PSi+1. The ISP simulator 140 tuned with new parameters may perform signal processing on the first image IMG1 to generate the (i+1)^{th} image IMGi+1. The ISP simulator 140 may provide the (i+1)^{th} image IMGi+1 to the IQA model IM. The (i+1)^{th} image IMGi+1 may correspond to a changed (or next) state variable S(t+1).

The IQA model IM may obtain the (i+1)^{th} image IMGi+1. The IQA model IM may output an evaluation on the (i+1)^{th} image IMGi+1. For example, the IQA model IM may output an evaluation score SC for the (i+1)^{th} image IMGi+1. In the IQA model IM, the evaluation score SC may correspond to a reward R(t). The IQA model IM may provide the evaluation score SC to the tuning model TM. The tuning model TM may update a policy or update a Q-table based on the evaluation score SC. The tuning model TM may receive the (i+1)^{th} image IMGi+1 and the (i+1)^{th} parameter set PSi+1.

When a tuning model is trained, the reinforcement learning module 152 may store the trained tuning model TM. In this case, the reinforcement learning module 152 may store the trained tuning model TM in the storage device 130. Alternatively, the reinforcement learning module 152 may store the trained tuning model TM in a memory of a server connected to the electronic device 100 via a wired or wireless network. Alternatively, the reinforcement learning module 152 may store the trained tuning model TM in a database.

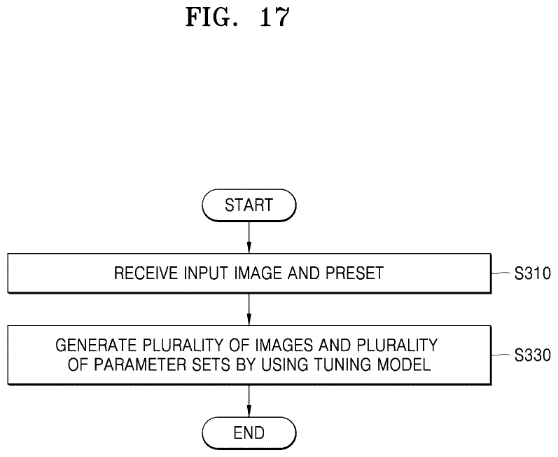

FIG. 17 is a flowchart of an example of a method of operating the tuning module 160 of FIG. 5.

Referring to FIGS. 5 and 17, operation S20 of FIG. 3 may include operations S310 and S330. The tuning module 160 may perform a tuning operation. The tuning module 160 may generate a parameter set for tuning the ISP simulator 140 (or ISP). The tuning module 160 may generate a parameter set based on a preset.

In operation S310, the tuning module 160 may obtain an input image and a preset. The tuning module 160 may receive the preset from the storage device 130. Alternatively, the tuning module 160 may receive the preset from a server connected to the electronic device 100 via a wired or wireless network. Alternatively, the tuning module 160 may receive the preset from a database.

In at least one embodiment, the tuning module 160 may receive the first type preset T1_PS. The tuning module 160 may receive the parameter list PL and the tuning model TM included in the first type preset T1_PS.

In at least one embodiment, the tuning module 160 may receive the second type preset T2_PS. The tuning module 160 may receive the parameter list PL and the IQA model IM included in the second type preset T2_PS.

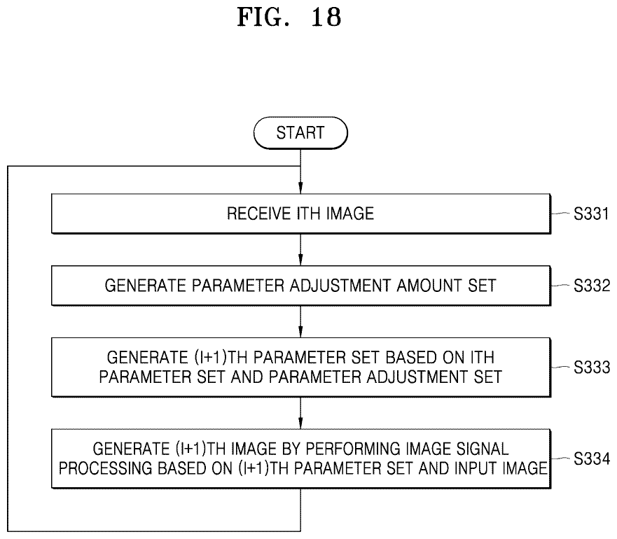

In operation S330, the tuning module 160 may generate a plurality of images and a plurality of parameter sets by using the tuning module 160. In at least one embodiment, a signal-processed image having a high evaluation score of the IQA model IM does not necessarily correspond to an image in which user preferences are best reflected. The tuning module 160 may also provide generated intermediate output images and intermediate parameter sets to the user until an optimal output image or optimal parameter set is generated. In other words, the tuning module 160 may provide a plurality of output images and a plurality of parameter sets. The plurality of output images may include an optimal output image and intermediate output images. The plurality of parameter sets may include an optimal parameter set and intermediate parameter sets. For example, the user may select a most preferred output image from among the plurality of output images. A parameter set corresponding to the output image selected by the user may be applied to an ISP. Accordingly, the user may directly select a parameter set in which preferences are reflected. FIG. 18 is a flowchart of operation S330 of FIG. 17 in detail.

Referring to FIGS. 5, 17, and 18, operation S330 of FIG. 17 may include operations S331 to S334. The tuning module 160 may perform a tuning operation to generate an output image and a parameter set. The output image may be an image with improved image quality. The parameter set may be an optimal parameter set.

In at least one embodiment, the tuning module 160 may perform a first tuning operation or second tuning operation. The first tuning operation may refer to a tuning operation performed based on the first type preset T1_PS. In some embodiments, the first tuning operation may not include a tuning model training operation. The second tuning operation may refer to a tuning operation performed based on the second type preset T2_PS. The second tuning operation may include a tuning model training operation. In at least one embodiment, the tuning model training operation may correspond to a reinforcement learning operation of the profiling module 150.

In at least one embodiment, the tuning module 160 may perform a tuning operation to generate a plurality of output images and a plurality of parameter sets. The tuning model TM may repeat a loop including operations S331 to S334 to generate an optimal parameter set. The tuning model TM generate, while repeating operations S331 to S334, intermediate output parameter sets and intermediate output images in addition to the optimal parameter set and the optimal output image. The plurality of output images generated by the tuning module 160 may include an optimal output image and intermediate output images. The plurality of parameter sets generated by the tuning module 160 may include an optimal parameter set and intermediate parameter sets.

The tuning module 160 may obtain an input image. The ISP simulator 140 may perform signal processing on the input image to generate an output image. The input image may correspond to a first image in the operation described below. For example, the first image corresponding to an initial state variable may be an input image. In at least one embodiment, the electronic device 100 may obtain an image stored in the electronic device 100. For example, the electronic device 100 may execute a photo album application or the like to obtain a pre-stored image.

In at least one embodiment, the electronic device 100 may receive an image from an external server or external electronic device. Here, the external server or external device may include a social network server, a cloud server, a web server, or a content providing server. For example, when at least one of a social network service (SNS) application, a web application, a video playback application, and a search application is selected in the electronic device 100, the electronic device 100 may approach the external or external device and receive an image. According to another example, the electronic device 100 may receive an image from an external device positioned around the electronic device 100 by using a short-range wireless network.

In at least one embodiment, the electronic device 100 may obtain a new image through a camera provided in the electronic device 100. For example, when a camera application or the like is executed in the electronic device 100, the electronic device 100 may detect an object positioned around the electronic device 100 and obtain a preview image. The preview image is an image provided to guide shooting of an object in a camera application or the like, and may be obtained by the electronic device 100 prior to shooting. In addition, the electronic device 100 may obtain an image of an object around the electronic device 100 (hereinafter, referred to as “capture image”) in response to a shooting request being received from the user while the preview image is obtained.

In addition, in operation S331, the tuning module 160 may receive the i^{th} image IMGi. Here, i may be a natural number. For example, the i^{th} image IMGi may correspond to the state variable S(t) of reinforcement learning.

In operation S332, the tuning module 160 may generate the parameter adjustment set PAS. The tuning module 160 may generate the parameter adjustment set PAS based on the i^{th} image IMGi. The parameter adjustment set PAS may include parameter adjustment amounts. The parameter adjustment set PAS may include adjustment amounts of parameters included in the parameter list PL. The parameter adjustment set PAS may correspond to the action variable A(t).

In operation S333, the tuning module 160 may generate the (i+1)^{th} parameter set PSi+1 based on the i^{th} parameter set PSi and the parameter adjustment set PAS. The tuning module 160 may generate the (i+1)^{th} parameter set PSi+1 by adjusting parameter values of the i^{th} parameter set PSi based on the parameter adjustment set PAS. The tuning module 160 may generate the (i+1)^{th} parameter set PSi+1 by combining the i^{th} parameter set PSi and the parameter adjustment set PAS.

In operation S334, the tuning module 160 may perform image signal processing based on the (i+1)^{th} parameter set PSi+1 and the input image IMG1 to perform the (i+1)^{th} image IMGi+1. For example, the tuning module 160 may tune the ISP simulator 140 (or ISP) based on the (i+1)^{th} parameter set PSi+1. The tuning module 160 may generate the (i+1)^{th} image IMGi+1 through the tuned ISP simulator 140 (or ISP). The (i+1)^{th} image IMGi+1 may correspond to the changed state variable S(t+1).

The tuning module 160 may stop repeating the loop when an optimal parameter set has been generated. The tuning module 160 may determine whether to repeat the loop based on predetermined criteria. The tuning module 160 may stop repeating the loop when it is determined that the optimal parameter set has been generated, and may output a plurality of output images and a plurality of parameter sets.

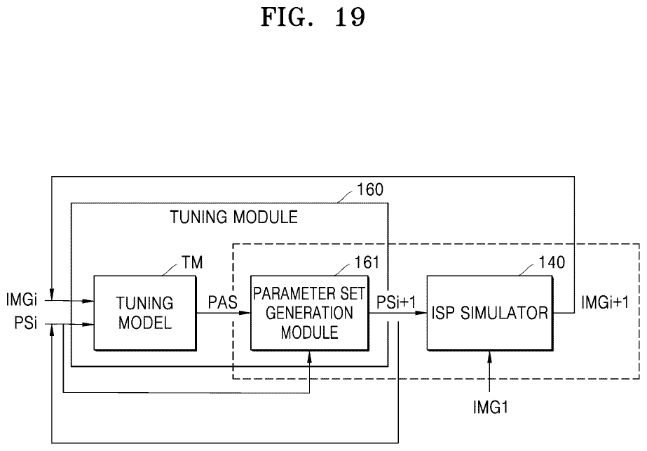

FIG. 19 is a diagram for describing a tuning operation of the tuning module 160 of FIG. 5.

Referring to FIGS. 5, 18, and 19, the tuning module 160 may perform a tuning operation. The tuning module 160 may include a parameter generation module 161. The parameter generation module 161 may generate a next parameter set (e.g., the (i+1)^{th} parameter set PSi+1) based on the parameter adjustment set PAS and a current parameter set (e.g., the i^{th} parameter set PSi). The parameter generation module 161 may generate the next parameter set (e.g., the (i+1)^{th} parameter set PSi+1) by combining the parameter adjustment set PAS and the current parameter set (e.g., the i^{th} parameter set PSi). The tuning module 160 may obtain the first type preset T1_PS. The tuning module 160 may obtain the parameter list PL and the tuning model TM. The tuning module 160 may generate a plurality of output images and a plurality of parameter sets based on the parameter list PL and the tuning model TM.

The tuning model TM may receive the i^{th} image IMGi corresponding to the state variable S(t). The tuning model TM may receive the i^{th} parameter set PSi. The i^{th} parameter set PSi may include values of parameters included in the parameter list PL.

The tuning model TM may generate the parameter adjustment set PAS. The parameter adjustment set PAS may include an adjustment amount (or change amount) of parameters included in the parameter list PL. The tuning model TM may output the parameter adjustment set PAS. The parameter adjustment set PAS may correspond to the action variable A(t). For example, the tuning model TM may generate the parameter adjustment set PAS, which is the action variable A(t) corresponding to the maximum reward in a received state.

The parameter generation module 161 may receive the i^{th} parameter set PSi and the parameter adjustment set PAS. The parameter generation module 161 may generate the (i+1)^{th} parameter set PSi+1 based on the i^{th} parameter set PSi and the parameter adjustment set PAS. The parameter generation module 161 may generate the (i+1)^{th} parameter set PSi+1 by performing an addition operation on the i^{th} parameter set PSi and the parameter adjustment set PAS.

The ISP simulator 140 may receive the (i+1)^{th} parameter set PSi+1. The ISP simulator 140 may receive the first image IMG1. For example, the first image IMG1 may be an input image. The first image IMG1 may be an input image on which signal processing is not performed. The ISP simulator 140 may be tuned with the (i+1)^{th} parameter set PSi+1. The ISP simulator 140 tuned with new parameters may perform signal processing on the first image IMG1 to generate the (i+1)^{th} image IMGi+1. The (i+1)^{th} image IMGi+1 may correspond to a changed (or next) state variable S(t+1).

For example, the tuning module 160 may determine a fourth image as an optimal or preferred output image. After the fourth image is generated, the tuning module 160 may not input the fourth image into the tuning module 160. The tuning module 160 may stop repeating the loop. The tuning module 160 may output the second to fourth images as a plurality of output images. The tuning module 160 may output the second to fourth parameter sets as a plurality of parameter sets.

For example, the electronic device 100 may perform a tuning operation and provide a plurality of parameter sets and a plurality of output images to the user. The electronic device 100 may provide the plurality of output images to the user through a display unit. Accordingly, the user may select a most preferred output image from among the plurality of output images. The electronic device 100 may display the plurality of output images. The electronic device 100 may determine an output image selected by a user input among the plurality of output images as a final output image. In response to a user input for touching at least one of the plurality of output images, the electronic device 100 may determine the selected output image as the final output image. A parameter set corresponding to an output image most preferred by the user (i.e., final output image) may be determined as the final parameter set. The ISP simulator 140 (or ISP) may be tuned with the final parameter set.

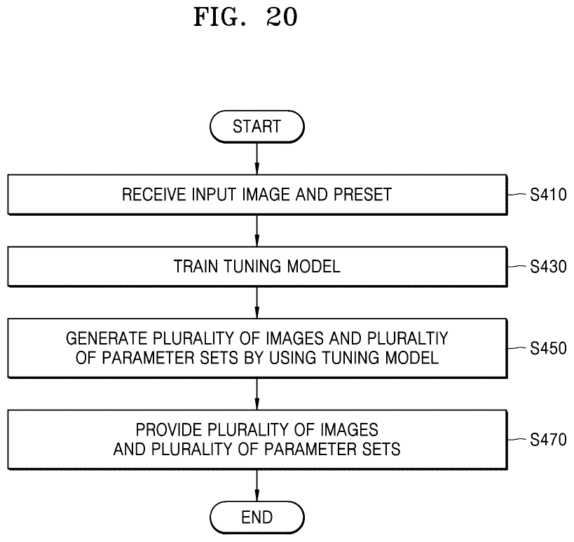

FIG. 20 is a diagram for describing a tuning operation of the tuning module 160 of FIG. 5.

Referring to FIGS. 3, 5, 12, 17, and 20, operation S20 of FIG. 3 may include operations S410 to S470. Operation S310 of FIG. 17 is identical or substantially similar to operation S410, and operation S33 of FIG. 17 is identical or substantially similar to operation S450, and thus redundant descriptions thereof are omitted. Operation S230 of FIG. 12 is identical or substantially similar to operation S430, and redundant descriptions thereof are omitted. A tuning model training operation of the tuning module 160 may correspond to a reinforcement learning operation of the profiling module 150. The tuning module 160 may perform a tuning operation. The tuning module 160 may generate a parameter set for tuning the ISP simulator 140. The tuning module 160 may generate a parameter set based on a preset.

In operation S410, the tuning module 160 may obtain an input image and a preset. The tuning module 160 may receive the second type preset T2_PS from the storage device 130. Alternatively, the tuning module 160 may receive the second type preset T2_PS from a server connected to the electronic device 100 via a wired or wireless network. Alternatively, the tuning module 160 may receive the second type preset T2_PS from a database. The tuning module 160 may obtain the parameter list PL and the IQA model IM.

In operation S430, the tuning module 160 may train the tuning model TM. The tuning module 160 may perform a reinforcement learning operation. The reinforcement learning operation of the tuning module 160 may be identical or similar to a reinforcement learning operation of the profiling module 150. The detailed description of the above is omitted.

Referring to FIG. 17, the tuning module 160 may obtain the first type preset T1_PS. The tuning module 160 may obtain the trained tuning module 160 and the parameter list PL. When the first type preset T1_PS has been obtained, the tuning module 160 may not train the tuning model TM.

In at least one embodiment, the tuning module 160 may train the tuning model TM when the second type preset T2_PS has been obtained. The tuning module 160 may train the tuning model TM based on the obtained parameter list PL and the IQA model IM. The tuning module 160 may obtain a training data set. The tuning module 160 may obtain a training data set in which user preferences are reflected. The tuning module 160 may train the tuning module 160 based on the training data set.

In operation S450, the tuning module 160 may generate a plurality of images and a plurality of parameter sets by using the tuning module 160. In operation S470, the tuning module 160 may provide a plurality of output images and a plurality of parameter sets. The tuning module 160 may store the plurality of parameter sets in the storage device 130. The tuning module 160 may provide the plurality of output images to a display unit (not shown). The tuning module 160 may provide the plurality of output images to the user through the display unit.

As described above, the tuning module 160 may perform a second tuning operation. In other words, the tuning module 160 may perform a tuning model training operation based on the second type preset T2_PS. The tuning module 160 may train the tuning model TM based on the training data set in which user preferences are reflected. The tuning module 160 may generate a plurality of output images and parameter sets based on the directly trained tuning model TM.

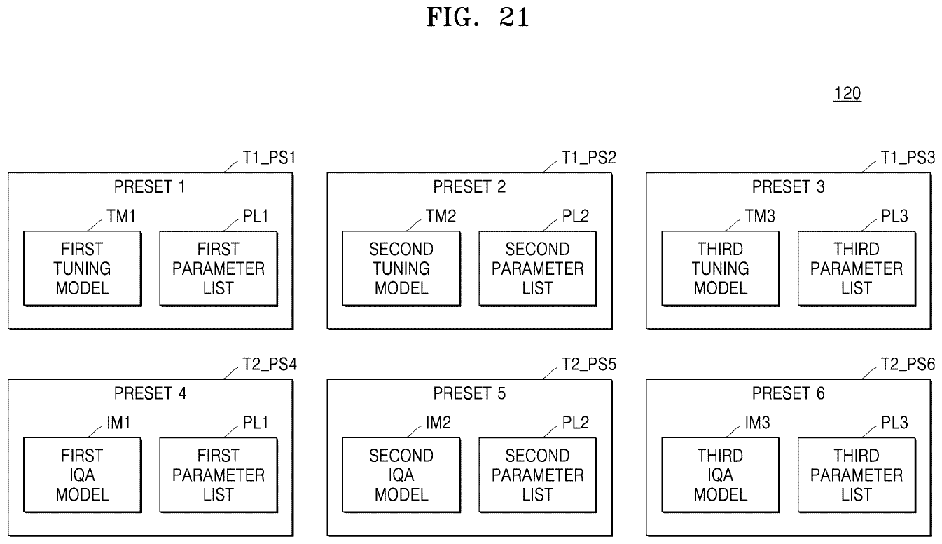

FIG. 21 is a diagram for describing a preset according to at least one embodiment.

The electronic device 100 may store a plurality of presets PS in the storage device 130. For example, the storage device 130 may include first to sixth presets T1_PS1, T1_PS2, T1_PS3, T2_PS4, T2_PS5, and T2_PS6.

In at least one embodiment, the electronic device 100 may generate the first type preset T1_PS and the second type preset T2_PS and store the generated first type preset T1_PS and second type preset T2_PS in the storage device 130. The electronic device 100 may generate and store presets according to features of an image.

The electronic device 100 may store the first type preset T1_PS and the second type preset T2_PS in the storage device 130. For example, each of the first to third presets T1_PS1, T1_PS2, and T1_PS3 may be the first type preset T1_PS. The first preset T1_PS1 may include a first tuning model TM1 and a first parameter list PL1. The second preset T1_PS2 may include a second tuning model TM2 and a second parameter list PL2. The third preset T1_PS3 may include a third tuning model TM3 and a third parameter list PL3.

For example, each of the fourth to sixth presets T2_PS4, T2_PS5, and T2_PS6 may be the second type preset T2_PS. The fourth preset T2_PS4 may include a first IQA model IMI and the first parameter list PL1. The fifth preset T2_PS5 may include a second IQA model IM2 and the second parameter list PL2. The sixth preset T2_PS6 may include a third IQA model IM3 and the third parameter list PL3.

The first preset T1_PS1 and the fourth preset T2_PS4 may be related to a first feature. For example, the first feature may be related to noise. The second preset T1_PS2 and the fifth preset T2_PS5 may be related to a second feature. For example, the second feature may be related to sharpness. The third preset T1_PS3 and the sixth preset T2_PS6 may be related to a third feature. For example, the third feature may be related to color.

In at least one embodiment, it is assumed that the user desires to tune an ISP regarding the first feature. The second electronic device 12 of FIG. 1 may obtain the first preset T1_PS1 or the fourth preset T2_PS4. In other words, the second electronic device 12 may obtain a preset corresponding to the first feature. For example, the second electronic device 12 may obtain the first preset T1_PS1. The second electronic device 12 may perform a tuning operation based on the first tuning model TM1. The second electronic device 12 may tune the ISP by reflecting user preferences. The second electronic device 12 may provide an output image in which the user preferences are reflected.

As described above, the electronic device 100 may efficiently tune the ISP parameters to suit the image features desired by the user. The electronic device 100 may custom tune the ISP according to user preferences. The electronic device 100 may provide the user with a tuning style to select based on pre-generated presets PS.

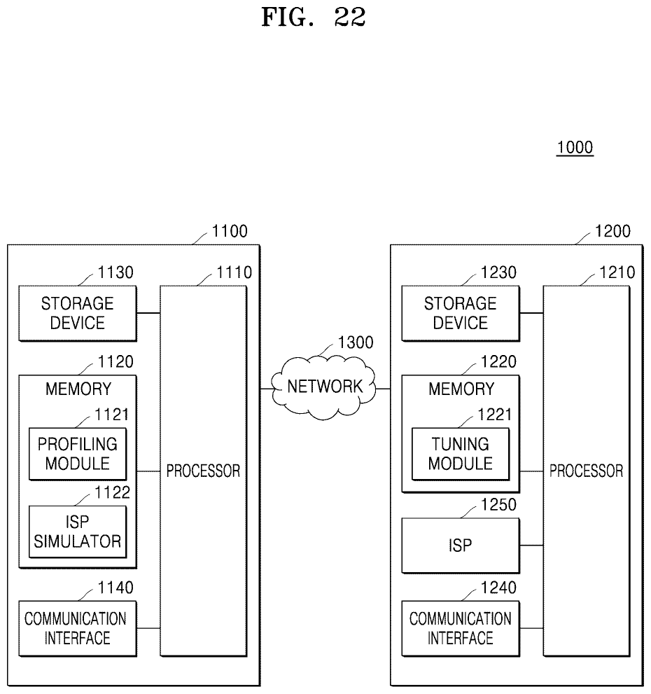

FIG. 22 is a block diagram illustrating a tuning system 1000 according to at least one embodiment.

The tuning system 1000 may include an electronic device (or server) 1100, an electronic device 1200, and a network 1300. The electronic device 1100 and the electronic device 1200 may be configured to communicate with each other via the network 1300. For example, the network 1300 may include a short-range wireless communication between devices as well as a communication scheme utilizing a mobile communication network, wired Internet, wireless Internet, broadcasting network, and/or the like. For example, the network 1300 may include any one or more of any of the following networks: an ad hoc network, an intranet, an extranet, a personal area network (PAN), a local area network (LAN), a wireless LAN, a campus area network (CAN), a metropolitan area network (MAN), a wide area network (WAN), a broadband network (BBN), a public switched telephone network (PSTN), the Internet, and/or the like. In at least one embodiment, the network 1300 may be implemented by using Ethernet. The network 1300 may be a general network such as a transmission control protocol (TCP)/Internet protocol (IP) network.

In at least one embodiment, the electronic device 1100 may include a processor 1110, a memory 1120, a storage device 1130, and a communication interface 1140. The memory 1120 may include a profiling module 1121 and an ISP simulator 1122.

The electronic device 1100 (or server) may be a device with higher computing performance than the electronic device 1100 so as to be able to perform more computationally intensive operations. The electronic device 1100 may train an artificial intelligence model, which requires a relatively large amount of computation.

The communication interface 1140 may include a communication circuit. The communication interface 1140 may include a communication circuit configured to performing data communication between the electronic device 1100 and other electronic devices by using at least one of data communication schemes including, for example, wired LAN, wireless LAN, Wi-Fi, Bluetooth, ZigBee, Wi-Fi Direct (WFD), infrared Data Association (IrDA), Bluetooth Low Energy (BLE), Near Field Communication (NFC), Wireless Broadband Internet (Wibro), World Interoperability for Microwave Access (WiMAX), Shared Wireless Access Protocol (SWAP), Wireless Gigabit Alliances (WiGig), and radio frequency (RF) communication.

The communication interface 1140 may be configured to transmit and receive data for tuning the ISP of the electronic device 1100 to and from an external electronic device. For example, the communication interface 1140 may transmit and receive artificial intelligence models used by the electronic device 1100, or transmit and receive a training data set for the artificial intelligence models to and from a server or the like.

The storage device 1130 may be configured to store data regardless of power supply. For example, the storage device 1130 may include at least one of various non-volatile memory, such as flash memory, PRAM, MRAM, ReRAM, and FRAM. For example, the storage device 1130 may include built-in memory and/or removable memory of the electronic device 1100. In at least one embodiment, the storage device 1130 may store instructions, programs, and/or data for executing at least some of the operations described above with reference to the drawings. In at least one embodiment, database may be established on the storage device 1130. A plurality of presets PS may be stored in the storage device 1130. A training data set may be stored in the storage device 1130.

The memory 1120 may store instructions, data structures, and program codes that may be read by the processor 1110. The memory 1120 may include one or more memories. In the disclosed embodiment, operations performed by the processor 1110 may be implemented by executing instructions or codes of a program stored in the memory 1120.

The memory 1120 may include non-volatile memory including at least one of flash memory type memory hard disk type memory, multimedia card micro type memory, card type memory (e.g., SD or XD memory), ROM, EEPROM, PROM, magnetic memory, a magnetic disk, and an optical disk, and volatile memory such as RAM or SRAM.

The memory 1120 according to at least one embodiment may store one or more instructions and/or programs that cause the electronic device 100 to operate to tune the ISP. For example, the memory 1120 may store the profiling module 1121 and the ISP simulator 1122.

The processor 1110 may be configured to control overall operations of the electronic device 100. For example, the processor 1110 may execute the one or more instructions of the program stored in the memory to control overall operations of the electronic device 1100 to tune the ISP and optimize image quality of an image. The processor 1110 may include one or more processors.

The one or more processors 1110 according to the inventive concepts may include at least one of a CPU, a GPU, an APU, a MIC, a DSP, and an NPU. The one or more processors 1110 may be implemented in the form of an integrated SoC including one or more electronic components. Each of the one or more processors may be implemented as separate H/W.

The processor 1110 may perform a data analysis operation by executing the processor 1110 to generate the IQA model IM and the generate the parameter list PL. In at least one embodiment, the profiling module 1121 may include the IQA model IM, which is an artificial intelligence model. The processor 1110 may train the tuning model TM by executing the profiling module 1121 to perform a reinforcement learning operation. In at least one embodiment, the profiling module 1121 may include the tuning model TM, which is an artificial intelligence model. Operations of the electronic device 1100 related to the profiling module 1121 are described in detail with reference to the previous drawings, and thus detailed descriptions thereof are omitted.

Meanwhile, the modules stored in the memory 1120 described above are for convenience of description, and the inventive concepts are not limited thereto. Other modules may be added to implement the embodiment described above.

The electronic device 1200 may include a processor 1210, a memory 1220, a storage device 1230, a communication interface 1240, and an ISP 1250. The processor 1210, the memory 1220, the storage device 1230, and the communication interface 1240 of the electronic device 1200 correspond to the processor 1110, the memory 1120, the storage device 1130, and the communication interface 1140 of the electronic device 1200, respectively, and thus redundant descriptions thereof are omitted.

The memory 1220 may store a tuning module 1221. The processor 1210 may generate a plurality of output images and a plurality of parameter sets by executing the tuning module 1221 to perform a tuning operation. In at least one embodiment, the tuning module 1221 may include the IQA model IM, which is an artificial intelligence model. In at least one embodiment, the tuning module 1221 may include the tuning model TM, which is an artificial intelligence model. Operations of the electronic device 1200 related to the tuning module 1221 are described in detail with reference to the previous drawings, and thus detailed descriptions thereof are omitted.

In at least one embodiment, the electronic device 1200 may further include a lens (not shown) and an image sensor (not shown). The ISP 1250 may receive light through the lens. The image sensor and the ISP 1250 may generate image information about an external object based on the received light. For example, the ISP 1250 may perform an operation of the ISP simulator 140 of FIG. 4. The ISP 1250 may perform signal processing on the input image based on a parameter set received from the tuning module 1221 to generate an output image. The ISP 1250 may receive a final parameter set generated by the tuning module 1221 and store the final parameter set in a register of the ISP 1250. The electronic device 1200 may apply the final parameter set to the ISP 1250.

In at least one embodiment, the memory 1120 of the electronic device 1100 may store the profiling module 1121, and the memory 1220 of the electronic device 1200 may store the tuning module 1221. Accordingly, the processor 1110 of the electronic device 1100 may execute the profiling module 1121 and perform a profiling operation. The processor 1210 of the electronic device 1200 may execute the tuning module 1221 and perform a tuning operation. The electronic device 1100 in which the profiling operation is performed and the electronic device 1200 in which the tuning operation is performed may be different from each other.

In at least one embodiment, models used by the electronic device 1200 may be trained by another electronic device 1100 (e.g., a local personal computer (PC), a server, and/or the like) configured to perform a neural network operation. For example, an IQA model, a tuning model, and/or the like may be trained in the other electronic device 1100 and stored in a completed learning state.

In at least one embodiment, the electronic device 1200 may receive trained models stored in other electronic devices. The electronic device 1200 may perform the tuning operation described above and image processing operations based on the received models. In this case, the electronic device 1200 may execute the trained models to perform a reinforcement learning operation and/or a tuning operation, and generate a plurality of signal-processed output images and optimal parameter sets. Information related to the generated output images may be provided to users through applications or the like.

In at least one embodiment, models (e.g., an IQA model and a tuning model) trained by the electronic device 1100 may be stored in a memory or storage device of the electronic device 1100. Alternatively, the models (e.g., an IQA model and a tuning model) trained by the electronic device 1100 may be transmitted to and stored in another electronic device (not shown) (e.g., a server, a cloud server, or the like). The electronic device 1200 may receive trained models stored in the electronic device 1100 that has trained the model, or in the other electronic device (not shown). The electronic device 1200 may perform the tuning operation described above and image processing operations based on the received models.

Meanwhile, as described with reference to the previous drawings, models used by the electronic device 1200 may be trained by using computing resources of the electronic device 1100. This is described in detail above, and thus redundant descriptions thereof are omitted.

When a method according to at least one embodiment includes a plurality of operations, the plurality of operations may be performed by one processor or a plurality of processors. For example, a first operation, a second operation, and a third operation are performed by the method according to at least one embodiment, all of the first operation, the second operation, and the third operation may be performed by a first processor, the first operation and the second operation may be performed by the first processor (e.g., a general-purpose processor), and the third operation may be performed by a second processor (e.g., an artificial intelligence-only processor) and/or the like. Here, an artificial intelligence-only processor, which is an example of the second processor, may perform operations for training/inference of an artificial intelligence model. However, at least one embodiment is not limited thereto.

One or more processors according to the inventive concepts may be implemented as a single-core processor or a multi-core processor.

When a method according to at least one embodiment includes a plurality of operations, the plurality of operations may be performed by one core or by a plurality of processors included in the one or more processors.

Although not shown in FIG. 22, the electronic device 100 may further include a user interface. The user interface may include an input interface for receiving a user input, and an output interface for outputting information.

The output interface may be for outputting video signals or audio signals. The output interface may include a display unit, a sound output unit, a vibration motor, and the like. When the display unit and a touch pad form a layered structure and constitute a touch screen, the display unit may be used as an input interface in addition to an output interface. The display unit may include at least one of a liquid crystal display, a thin film transistor-liquid crystal display, a light-emitting diode (LED), an organic light-emitting diode, a flexible display, a three-dimensional (3D) display, and an electrophoretic display. In addition, depending on the embodiment of the electronic device 100, the electronic device 100 may include two or more display units.

The sound output unit may output an audio signal received from a communication interface 3100 or stored in the memory 1120. In addition, the sound output unit may output an acoustic signal related to a function performed in the electronic device 100. The sound output unit may include a speaker, a buzzer, and the like.

The input interface may be for receiving an input from a user. The input interface may be at least one of a keypad, a dome switch, a touch pad (contact capacitance type, pressure resistive film type, infrared detection type, surface ultrasonic conduction type, integral tension measurement type, piezo effect type, or the like), a jog wheel, and a jog switch, but is not limited thereto. In some embodiments, the input interface may include a speech recognition module. For example, the electronic device 100 may receive a speech signal, which is an analog signal, through a microphone and convert the speech portion into computer-readable text by using an automatic speech recognition (ASR) model. The electronic device 100 may interpret the converted text by using a natural language understanding (NLU) model and obtain the user's speech intention. Here, the ASR model or the NLU model may be an artificial intelligence model. Linguistic understanding is a technology of recognizing and applying/processing human language/characters, including natural language processing, machine translation, dialog system, question answering, speech recognition/synthesis, and the like.

Embodiments may also be implemented in a form of a recording medium including instructions executable by a computer, such as a program module executed by a computer. A computer-readable medium may be a medium accessible by a computer, and includes all volatile and non-volatile media and separable and non-separable media. Further, the computer-readable medium may include a computer storage medium and a communication medium. Examples of the computer storage medium include all volatile and non-volatile media and separable and non-separable media, which have been implemented by an arbitrary method or technology, for storing information such as computer-readable instructions, data structures, program modules, and other data. The communication medium may typically include other data of a modulated data signal, such as a computer-readable instruction, a data structure, or a program module.

The computer-readable storage medium may be provided in the form of a non-transitory storage medium. Here, the “non-transitory storage medium” only denotes a tangible device and does not contain a signal (for example, electromagnetic waves). This term does not distinguish a case where data is stored in the storage medium semi-permanently from a case where the data is stored in the storage medium temporarily. For example, the “non-transitory storage medium” may include a buffer where data is temporarily stored.

According to at least one embodiment, a method according to various embodiments disclosed herein may be provided by being included in a computer program product. The computer program products are products that can be traded between sellers and buyers. The computer program product may be distributed in a form of machine-readable storage medium (for example, a compact disc read-only memory (CD-ROM)), or distributed (for example, downloaded or uploaded) through an application store or directly or online between two user devices (for example, smartphones). In the case of online distribution, at least a part of the computer program product (for example, a downloadable application) may be at least temporarily generated or temporarily stored in a machine-readable storage medium, such as a server of a manufacturer, a server of an application store, or a memory of a relay server.

As described above, the tuning system 1000 may provide optimized parameters according to user's needs by tuning parameters of an ISP. The tuning system 1000 may provide an output image in which user preferences are reflected. The tuning system 1000 may provide a framework that allows a user to tune an image directly captured by the user.

While the inventive concepts have been particularly shown and described with reference to embodiments thereof, it will be understood that various changes in form and details may be made therein without departing from the spirit and scope of the following claims.

What is claimed is:

1. A method of tuning an image signal processor by an electronic device, the method comprising:
obtaining an image evaluation model, the image evaluation model configured to output an evaluation on an image received by the image evaluation model;
determining key features of the image received by the image evaluation model based on the output the image evaluation model;
determining a parameter list based on the key features; and
training a tuning model based on the parameter list and the image evaluation model, the tuning model configured to output a parameter adjustment set based on an image received by the tuning model, and wherein the tuning model is a reinforcement learning model.

2. The method of claim 1, wherein the obtaining of the image evaluation model comprises:
receiving a training data set; and
using a neural network to train the image evaluation model based on the training data set.

3. The method of claim 2, wherein
the image evaluation model comprises a large language model, and
the evaluation on the image comprises an evaluation score and evaluation content.

4. The method of claim 1, wherein the obtaining of the image evaluation model comprises:
extracting statistical data and feature data from the image received by the image evaluation model; and
generating the image evaluation model based on an analysis of the statistical data and the feature data.

5. The method of claim 1, wherein the training of the tuning model comprises:
receiving a first image;
generating a parameter adjustment set for the first image;
generating a second parameter set based on a first parameter set and the parameter adjustment set;
generating a second image by performing, based on the second parameter set and a raw image, image signal processing;
determining an evaluation score for the second image using the image evaluation model; and
updating the tuning model based on the evaluation score.

6. The method of claim 1, further comprising:
storing a first type preset in a storage device, the first type preset comprising the image evaluation model and the parameter list.

7. The method of claim 1, further comprising:
storing a second type preset in a storage device, the second type preset comprising the tuning model and the parameter list.

8. An electronic device configured to train a tuning model, the tuning model being a reinforcement learning model, the electronic device comprising:
at least one processor; and
a memory storing instructions configured to, when executed by the at least one processor, cause the electronic device to
obtain an image evaluation model configured to output an evaluation on an image received by the image evaluation model,
determine key features of the image received by the image evaluation model based on the output of the image evaluation model,
determine a parameter list based on the key features, and train a tuning model, based on the parameter list and the image evaluation model, the tuning model configured to output a parameter adjustment set based an image received by the tuning model.

9. The electronic device of claim 8, wherein to obtain the image evaluation model the electronic device is configured to:
receives a training data set; and
uses a neural network to train the image evaluation model based on the training data set.

10. The electronic device of claim 9, wherein
the image evaluation model comprises a large language model, and
the evaluation on the image comprises an evaluation score and evaluation content.

11. The electronic device of claim 8, wherein to the obtain the image evaluation model the electronic device is configured to:
extracts statistical data and feature data from the image received by the image evaluation model; and
generating the image evaluation model based on an analysis of the statistical data and the feature data.

12. The electronic device of claim 8, wherein to train of the tuning model the electronic device is configured to:
receive a first image;
generate a parameter adjustment set for the first image;
generate a second parameter set based on a first parameter set and the parameter adjustment set;
generate a second image by performing, based on the second parameter set and a raw image, image signal processing;
determine an evaluation score for the second image using the image evaluation model; and
update the tuning model based on the evaluation score.

13. The electronic device of claim 12, wherein
the first image corresponds to a state variable of reinforcement learning,
the parameter adjustment set corresponds to an action variable of the reinforcement learning,
the second image corresponds to a next state variable of the reinforcement learning, and
the evaluation score corresponds to a reward variable of the reinforcement learning.

14. The electronic device of claim 8, wherein the at least one processor is further configured to execute the one or more instructions to:
store, in a storage device, a first type preset comprising the image evaluation model and the parameter list.

15. The electronic device of claim 8, wherein the at least one processor is further configured to execute the one or more instructions to:
store, in a storage device, a second type preset comprising the tuning model and the parameter list.

16. The electronic device of claim 8, wherein the at least one processor is further configured to execute the one or more instructions to:
generate a plurality of output images and a plurality of parameter sets based on a first type preset comprising the tuning model and the parameter list.

17. The electronic device of claim 16, wherein to generate the plurality of output images and the plurality of parameter sets based on the first type preset the electronic device is configured to:
receiving a first image;
generating a parameter adjustment set for the first image;
generating a second parameter set based on a first parameter set and the parameter adjustment set; and
generating a second image by performing, based on the second parameter set and an input image, image signal processing.

18. The electronic device of claim 8, further comprising:
a storage device comprises
a first preset comprising a first tuning model and a first parameter set corresponding to a first image feature,
a second preset comprising a second tuning model and a second parameter set corresponding to a second image feature, and
a third preset comprising a third tuning model and a third parameter set corresponding to a third image feature.

19. The electronic device of claim 18, wherein the storage device further comprises:
a fourth preset comprising a first image evaluation model and a first parameter set corresponding to the first image feature;
a fifth preset comprising a second image evaluation model and a second parameter set corresponding to the second image feature; and
a sixth preset comprising a third image evaluation model and a third parameter set corresponding to the third image feature.

20. A computer-readable recording medium, having recorded thereon a program, configured to, when executed by at least one processor, cause a device to execute the method of claim 1.
